(19) United States
(12) Patent Application Publication
(10) Pub. No.: US 2017/0099228 A1
(43) Pub. Date: Apr. 6, 2017

(54) Mobile Device With In-Situ Network Activity Management

(71) Applicant: Headwater Partners I LLC, Tyler, TX (US)

(72) Inventors: Nathan Hunsperger, San Francisco, CA (US); Vien-Phuong Nguyen, Milpitas, CA (US); Chih-Yu Chow, Palo Alto, CA (US)

(21) Appl. No.: 15/279,990

(22) Filed: Sep. 29, 2016

Related U.S. Application Data
(60) Provisional application No. 62/236,850, filed on Oct. 2, 2015.
(60) Provisional application No. 62/258,279, filed on Nov. 20, 2015.

(51) Int. Cl. H04L 12/851; G06F 9/46; H04L 12/26

(52) U.S. Cl. CPC H04L 47/2441; H04L 43/0894; H04L 47/2483; G06F 9/466; H04W 28/10

(57) ABSTRACT

A wireless end-user device divides the functions of a network data policy management function between kernel and user-space processes. The kernel process is efficient at implementing control policies (block/allow/rate limit/usage limit) and counting policies for flows, but relies on the user-space process to classify flows and supply the control and counting policies for each flow. The kernel process allows the majority of the network data policy management function to run in a secure, power-efficient manner, with the user-space process remaining flexible and potentially sophisticated in classification capability, while having limited access to detailed packet flow information.

### TECHNICAL FIELD

The present disclosure relates to the field of wireless mobile devices, and more specifically to in-situ network activity management within wireless mobile devices.

### BRIEF DESCRIPTION OF THE DRAWINGS

The various embodiments disclosed herein are illustrated by way of example, and not by way of limitation, in the figures of the accompanying drawings and in which like reference numerals refer to similar elements.

FIG. 1 illustrates a mobile device capable of operating in either an in-network classification/control configuration 101 or an in-situ classification/control configuration, the latter being shown in two different implementations, 103 and 105.

FIG. 2 illustrates an exemplary distribution of policy-enforcement/traffic-counting functions and flow classification/data-rationing functions between kernel and userland processes.

FIG. 3 illustrates exemplary interactions between and operations within a kernel layer packet handler 201 (including and/or spawning a message handling service, 205) and kernel-layer policy enforcement engine 203.

FIG. 4 illustrates a conceptualized packet flow between a physical signaling interface (PHY) and application processes (Apps) within a wireless mobile device.

FIG. 5 illustrates a continuation of the packet flow shown in FIG. 4 after a data-ration allocated to the bottom-most flow has been depleted followed by a policy change from allow to block (i.e., policy change effected by a userland verdict rendered in response to a reclassification request).

FIG. 6 illustrates a further continuation of the packet flow shown in FIGS. 4 and 5, in this case demonstrating a kernel-level policy-clearing operation directed by the userland daemon in response to a change in mobile device operating context—in this case, a change in device state, policy state, usage state, etc. that impacts all or at least multiple flow control policies, referred to herein as a “global context.”

FIG. 7 illustrates an alternative (or additional) approach to managing global context changes that avoids the all-flow-reclassification approach shown in FIG. 6.

FIG. 8 illustrates a further policy enforcement example in view of the exemplary packet flow shown in FIGS. 4 and 5, in this case implementing a flow policy table that accounts for flow-specific contexts (e.g., attributes of specific flows and/or their network or user-layer destinations).

FIG. 9 illustrates the kernel-to-userland messaging memory may be allocated either in kernel space or user space, with each allocation scheme having attendant advantages.

FIG. 10 illustrates a full-rationing example in which a full data allocation is rationed to a flow in response to a new-flow classification request (i.e., rationed by collaboration between userland daemon and policy-enforcement engine/messaging service as discussed above).

FIG. 11 illustrates an incremental rationing approach achieved through successive allocation of fractional portions of a total available data allocation.

FIG. 12 illustrates an approach similar to incremental rationing, but with the initial incremental ration limited (chosen) to force a reclassification after a predetermined number (N) of initial packets, thereby permitting userland inspection of the (N+1)^{th} packet at reclassification.

FIG. 13 illustrates another approach referred to herein as depletion-alerting or water-marking. In this case, one or more alert levels or low-water marks may be associated with a bucket and the policy enforcement engine modified to convey an alert message (e.g., via the above-described messaging memory) upon determining that the alert level (low-water mark) has been reached (or that the bucket level has fallen below the low-water mark).

FIG. 14 illustrates an exemplary ring-buffer implementation of a messaging memory and examples of userland-sourced and kernel-sourced messages that may be conveyed via the messaging memory.

FIG. 15 illustrates non-exhaustive examples of bilateral and unilateral transactions that may be effected by posting one or more of the message types shown in FIG. 14.

FIG. 16 illustrates exemplary embodiments of a context-agnostic flow policy table and corresponding bucket table (rationing table) that may be used to implement like-named tables within the policy enforcement engine of FIG. 3.

FIG. 17 illustrates an alternative flow policy table that may be implemented to support kernel-level sensitivity to one or more global contexts.

FIG. 18 illustrates an exemplary flow policy table implementation that enables policy resolution in view of both global and flow-specific contexts.

FIG. 19 illustrates, within an abstraction 1900 of a typical Android/Linux execution environment, modular portions of service processor software for implementing the mobile end-user device portion of various network activity service plans and policies described below with reference to FIGS. 27-34.

FIG. 20 illustrates, within an abstraction 2000 of a typical Android/Linux execution environment (an identical environment to abstraction 1900 of FIG. 19), modular portions of service processor software for implementing the mobile end-user device portion of the type of network activity service plans and policies described below with reference to FIGS. 27-34, but in this embodiment with a generic flow classification, control, and counting (GFCCC) module 2016.

FIG. 21 illustrates the major components of GFCCC kernel module 2016 and the connections to NAM API 2014.

FIG. 22 illustrates one configuration of a UID policy table 2145.

FIG. 23 illustrates one configuration of a flow policy table 2155.

FIG. 24 illustrates one configuration of a UID bucket table 2165 and a policy bucket table 2167.

FIG. 25 illustrates an exemplary set of API calls implemented by NAM API 2014.

FIG. 26 contains a block diagram for one embodiment of CCC daemon 2026.

FIG. 27 illustrates an exemplary device-assisted network in which service plans applicable to an end-user device may be designed using, and provisioned using instructions generated by, an integrated service design center 2701.

FIG. 28 illustrates the integrated service design center 2730 conceptually, depicting high-level service design and provisioning operations together with a non-exhaustive list of design center capabilities and features.

FIG. 29 illustrates exemplary policy elements that may be defined using and provisioned by the integrated service design center of FIG. 28.

FIG. 30 illustrates an exemplary joint policy design—a combination of access-control, notification, and accounting policies or any two of those three policy types—that may be defined and provisioned using the integrated service design center of FIG. 28.

FIG. 31 illustrates a hierarchical service plan structure.

FIG. 32 illustrates an exemplary approach to managing policy priority within the integrated service design center of FIG. 28 that leverages the design hierarchy of FIG. 31.

FIG. 33 illustrates an example of a Z-ordered classification sequence with respect to the filters associated with two plan classes: sponsored and user-paid; and also two component classes: sponsored and open access.

FIG. 34 illustrates another example of Z-ordered classification within a plan catalog having plan classes and component classes, service policy components and plans similar to those shown in FIG. 33, except that the non-expiring 50 MB General Access Plan has been replaced by a one-week 50 MB General Access Plan.

### DETAILED DESCRIPTION

Mobile devices that implement collaborative in-situ network activity management within a kernel-instantiated policy-enforcement/counting engine and a user-layer classification/data-rationing engine are disclosed in various embodiments herein. Managing network activity predominantly within the mobile device (i.e., in-situ) rather than in the network back-end, permits implementation of on-the-fly customizable wireless device data service plans and service usage controls and accounting. In a number of embodiments, for example, device-assisted services (DAS) are employed to implement sophisticated and trusted on-device data traffic controls and measurements as described, for instance, in U.S. Pat. No. 8,839,388, entitled “Automated Device Provisioning and Activation,” U.S. Pat. No. 8,725,123, entitled “Communications Device with Secure Data Path Processing Agents,” U.S. Pat. No. 8,606,911, entitled “Flow Tagging for Service Policy Implementation,” and U.S. patent application Ser. No. 13/842,172, filed Mar. 15, 2013, entitled “Network Service Design Plan,” each which is hereby incorporated by reference in its entirety.

Further, bifurcation of relatively complex and volatile classification/data-rationing functions and real-time policy-enforcement/counting functions between user-layer and kernel-layer processes enables robust and agile service delivery without compromising security or bloating kernel space implementations. In a number of embodiments described below, for example, the vast majority of packets received or transmitted by a mobile device are subject to secure, low-latency policy enforcement and usage counting exclusively within the kernel, with user-layer interaction required only at the outset of a given packet flow (initial classification) and, in some cases, upon depleting a finite data ration allocated to a given flow. Moreover, implementing relatively complex and ever-changing flow classification and data-rationing functions within limited-permission user-layer process(es) enables those functions to be readily modified (changed, enhanced, debugged, etc.) without kernel revision, and executed with a limited, prescribed set of permissions instead of the unconstrained permission range afforded in kernel-space execution—both critical advantages as device vendors and kernel providers strive to enhance the security and stability of their device operating systems. These and other embodiments and features are described in greater detail below.

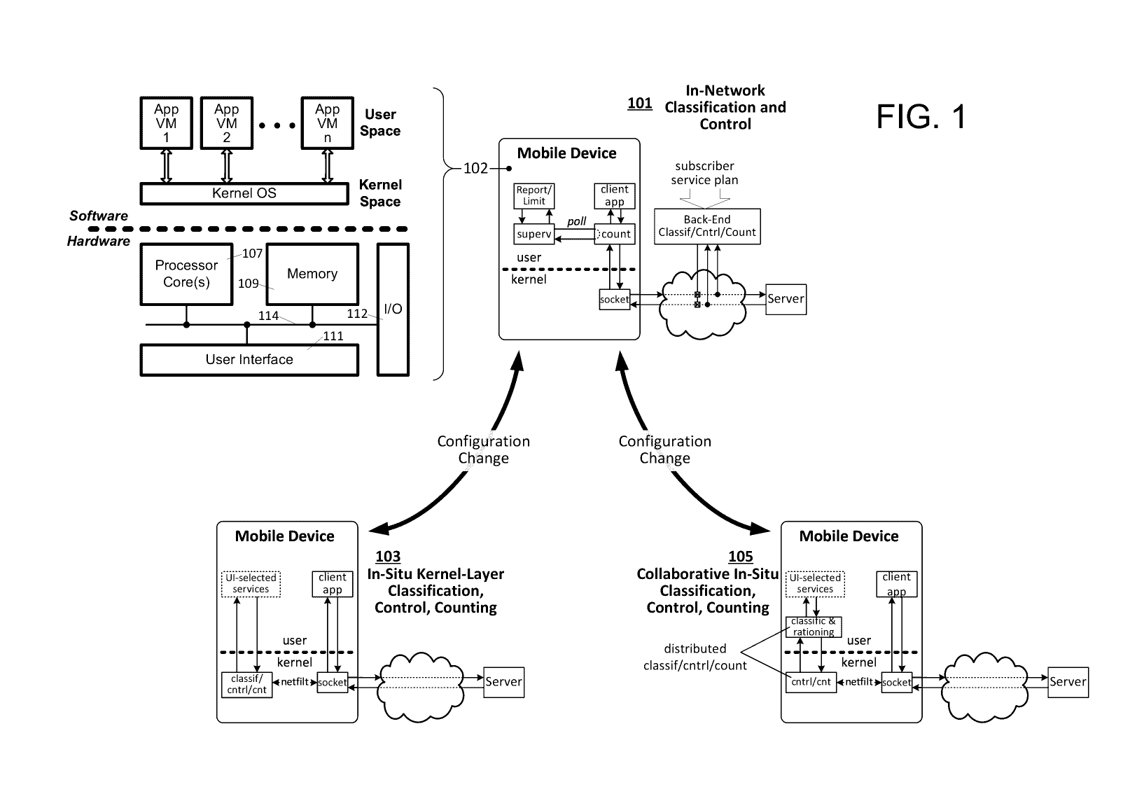

FIG. 1 illustrates a mobile device capable of operating in either an in-network classification/control configuration 101 or an in-situ classification/control configuration, the latter being shown in two different implementations, 103 and 105. While generally discussed herein in the context of a smart-phone capable of executing various user applications, the mobile device may constitute any electronic device capable of receiving and/or delivering services via a wireless network in the form of packetized data flows including, for example and without limitation, personal computing devices (tablet, laptop or other portable computing device, desktop or other predominantly wall-powered computing devices), network-accessible kiosks or like point-of-sale machines, network appliances of various types, mobile phones, etc. Also, in alternative embodiments, the mobile device may be implemented to operate exclusively in any one of the three configurations depicted in FIG. 1 and/or in other configurations or modes discussed below.

As shown at 102, the mobile device includes an underlying hardware architecture and “software” components instantiated by program code execution within that architecture. The conceptualized hardware architecture includes one or more processor cores 107 (including general-purpose and/or special-purpose processors), memory 109 (including various classes of storage, ranging, for example and without limitation, from high-speed static random access cache memory (SRAM) to more capacious dynamic random access operating memory (DRAM), to possibly even more capacious non-volatile storage (e.g., flash memory or other low-cost-per-bit storage), user interface 111 (including display, touch-screen, keypad, microphone, optical sensor, etc.) and various input/output interfaces 112 (including, for example, one or more radios and counterpart modems to implement wireless transceivers, transmitters and/or receivers according to various communications standards (WIFI, cellular network, Bluetooth, Near-Field, GPS, etc.), sensors of various types (optical imaging array, accelerometer, gyroscope, etc.), output devices (camera-flash/light-emission, vibration or other haptic-feedback, speaker, etc.) and wired interfaces for charging an internal battery of the mobile device and/or data exchange via proprietary or standard protocols (e.g., Apple lightning cable interface/receptacle, micro-USB, Ethernet, etc.), all interconnected by signaling links 114 (which may include any number of distinct signaling paths connected in topologies other than the unified-interconnect topology shown).

The various software components illustrated in FIG. 1 may be distinguished as either kernel components (or kernel-layer components or kernel-space components) or user-space components (also referred to herein as userland components) according to the runtime permissions afforded to those components. In general, the kernel space includes a kernel operating-system (OS) component (“Kernel OS”), or simply “kernel” for brevity, together with various hardware device drivers (which may be viewed as part of the kernel OS). While the kernel OS generally operates with a full range (unlimited) permissions and thus may access any and all memory space, user-space components operate with a more limited set of permissions, generally limiting their memory accessibility to individual and distinct memory ranges mapped/allocated to their respective virtual memory spaces. In the particular embodiment shown, the user-space components include a number of applications or “Apps” (processes, any or all of which may be multi-threaded) each executing in its own virtual machine (“VM”) wrapper—that is, within an emulated processing environment having its own virtual address space distinct from that of VM wrappers for other applications. Though not specifically shown in FIG. 1, the user-space may be decomposed into a permission-hierarchy with various protected system services (e.g., application framework(s), application runtime(s), network interface(s), etc.) at the bottom layer of the hierarchy with relatively robust permissions (but less than the kernel OS), protected user applications at the next level of the hierarchy (with fewer permissions), and then general user applications at the top of the hierarchy and with fewest permissions. In general, reference to user-space or userland entities herein may include processes that execute at any level of the userland-permission hierarchy including processes that straddle one or more hierarchical levels.

Still referring to FIG. 1, when the mobile device is operated according to in-network classification/control configuration 101, packet traffic between a user-space client application (i.e., executing instance of application code) and network-based server is subject to classification, control and counting by various appliances as it passes through the network, thus requiring such “back-end” appliances to be pre-programmed in accordance with a subscriber-paid service plan—generally one of a relatively small number of intractable plan offerings in view of the complexity and expense of establishing real-time cloud-based metering and policy enforcement.

Despite the in-network traffic classification, policy enforcement and counting, the mobile device may implement its own data usage reporting and monitoring. In the specific example shown, for instance, a user-land traffic counting process (“count”) may count network traffic tagged with application identifiers or other information that permits per-application data usage measurement, thus producing tallies that may be occasionally polled by a supervisory process (“superv,” also instantiated in userland) via an inter-process communication channel, reporting the usage to an application that displays the usage to a human operator (the “user”) and receives input from the user regarding coarse data limits. In one embodiment, user-specified data usage limits are supplied to the supervisor, which, upon determining that a given application has exceeded its data usage limit, may instruct the counting process to block further traffic bearing the subject application tag.

The user-land traffic control scheme shown with respect to an in-network classification/control configuration 101 may be sufficient for coarse data usage reporting and limiting substantial data overages, but is subject to a number of disadvantages with respect to in-situ traffic control. First, the inter-process communication (polling interface) between the supervisor process and tagged-traffic counting process tends to be compute-intensive, adding latency and sapping battery power at a rate that makes real-time control impractical in many hardware platforms. The tagging interface used to distinguish network traffic adds further latency, and the userland implementation brings security risks (e.g., loss of non-backed data usage tallies upon battery removal).

Referring to in-situ configuration 103, classification, control and counting implemented within the kernel layer avoids the inter-process latency and traffic tagging burden of configuration 101 and permits volatile tallies to be reliably captured in response to detected power loss (a kernel feature). On the other hand, the increased complexity of the kernel OS that results from incorporating potentially complex and voluminous traffic classification rules (including specification of various context-dependent control, notification and counting actions), coupled with unlimited kernel permissions, yield increased exposure to accidental/intentional compromise (including destruction) of sensitive and/or critical information, or a loss of device functionality that affects the ability of the device to use network connections. Moreover, should a bug be discovered in the kernel-based classification/control/counting engine, or a new feature be desired, the bug-fix/feature-update may need to await the next kernel OS update in accordance with third party maintenance schedule (i.e., next update from kernel OS supplier) and/or coordination delay as the kernel OS supplier may wish to independently verify kernel stability and security in view of the proposed bug-fix/feature-update.

Turning to the collaborative in-situ configuration shown at 105, recognizing that relatively volatile classification and data-rationing functions need be applied only to a relatively small number of packets (i.e., leading packet(s) of a new flow, or upon depleting a data usage allocation) while control and counting functions are applied to every packet in the flow (and thus demand efficient, low-latency processing), those respective sets of functions—classification/data-rationing and control/counting—are split (distributed) between userland and kernel-space implementations, respectively. Through this functional bifurcation, the vast majority of packets received or transmitted by the mobile device in collaborative in-situ configuration 105 are subject to low-latency policy-enforcement and usage counting exclusively within the kernel, with user-layer interaction required only at the outset of a given packet flow (initial classification) and, in some cases, upon depleting a finite data ration allocated to the packet flow. Further, by implementing flow classification and data rationing functions within user-layer process(es), those functions may be updated without changing the kernel (thus liberating the network activity management policy design and deployment from the kernel update schedule) and more securely executed (i.e., in view of the more restrictive userland permission set).

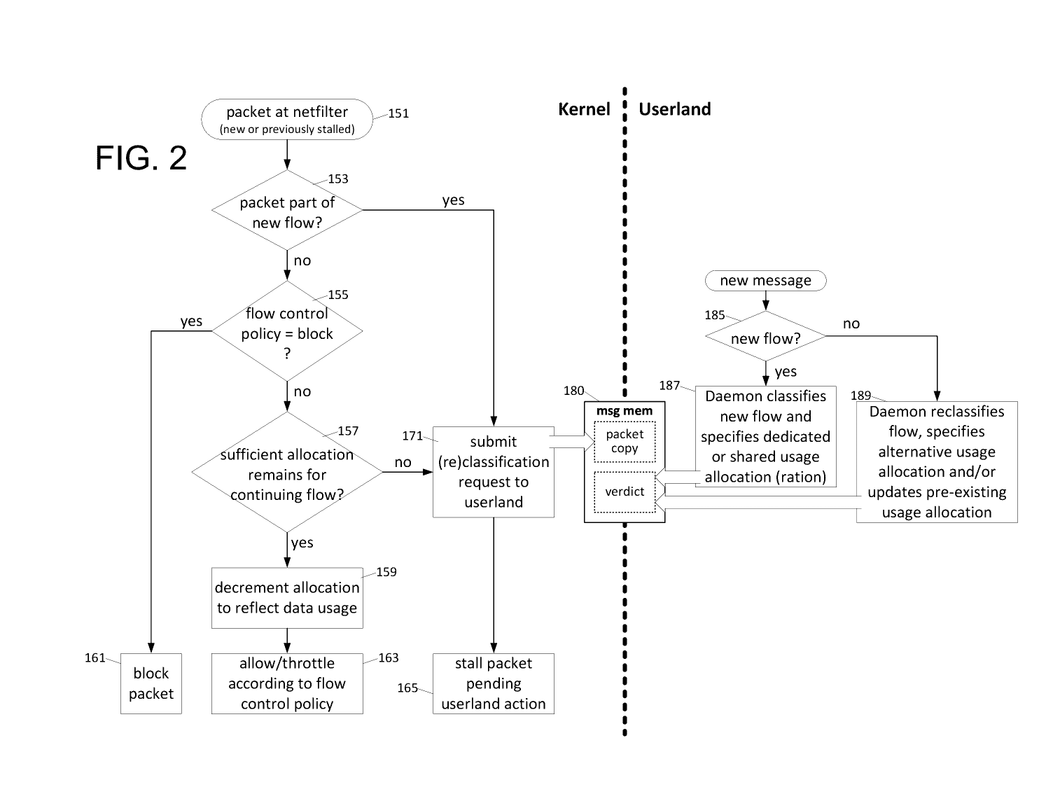

FIG. 2 illustrates an exemplary distribution of policy-enforcement/traffic-counting functions and flow classification/data-rationing functions between kernel and userland processes. In the particular example shown, the userland process is implemented, at least in part, by a background process or “daemon” (i.e., operating without direct control from an interactive user), though the daemon itself may communicate directly or indirectly with one or more user-interactive processes. Similarly, for purposes of specificity and understanding, the kernel process(es) of interest are assumed to be launched by and thus form extensions of a Linux kernel OS, though like functionality may be achieved with respect to any other kernel OS, extant or hereafter developed. Accordingly, starting with the kernel-space control/counting process, a packet propagating through the multi-layer stack of an internet protocol suite is made available for inspection via a kernel OS service as shown at 151—in this case via a netfilter hook that enables registration of a function to be invoked (or process to be launched) upon packet ascension/descension to a particular point in the protocol stack, thereby triggering execution of the depicted control/counting process.

At 153, the kernel-layer control/counting process, referred to herein as a policy enforcement engine or policy enforcer, inspects the packet content to determine whether the packet is part of a new flow. In a number of embodiments, for example, the policy enforcement engine derives a flow identifier (“flow ID”) from a 5-tuple of packet header fields that include the source/destination port numbers, source/destination IP (internet-protocol) addresses and transport-layer protocol specifier (e.g., TCP, UDP, etc.) and applies the flow ID to a dynamically updated flow-policy table. If the flow ID is found in the flow-policy table, then the packet is deemed part of a previously classified flow thus yielding a negative determination at 153. Conversely, if the flow ID is not present in the flow-policy table, the packet is deemed part of a new flow (affirmative determination at 153 and submitted to userland at 171 in a packet classification request. In the particular embodiment shown, upon submitting a classification request at 171 (or reclassification request as discussed below), the policy enforcer may return a “stall” value to the netfilter process at 165 signaling that packet propagation through the protocol stack is to be suspended (packet to be “stalled”) pending userland response to the classification request.

Continuing with FIG. 2, if the flow ID extracted from the netfilter-posted packet is found in the flow-policy table (packet is a constituent of a previously classified flow rather than a new flow), then the policy enforcer evaluates the flow control policy within the flow-ID-indexed table entry at 155. If the policy indicates that the flow is to be blocked (affirmative determination at 155), the policy enforcer returns a “block” control value to the netfilter process at 161 signaling that packet propagation is to be blocked, in effect, denying the source-requested packet delivery. If the flow control policy is other than “block” (negative determination at 155), then the data ration associated with the flow-ID-indexed flow control policy is evaluated at 157 to determine whether sufficient allocation remains for continuing the flow (i.e., allowing propagation of the packet to its destination). If insufficient allocation remains, a reclassification request is submitted to userland at 171 and the packet is stalled at 165 pending userland action. If sufficient allocation remains for continuing the flow, the allocation (or data ration) is decremented at 159 in accordance with packet size to reflect the data usage (i.e., passage of data through one or more networks). Thereafter, the packet is allowed (or throttled—a rate-restricted packet allowance) at 163 according to the flow control policy.

In the embodiment of FIG. 2, classification and reclassification requests are submitted to userland via a shared memory structure referred to herein as “messaging memory” 180. As discussed below, the messaging memory may be allocated in either userland or kernel address space and rendered accessible to the non-allocating process (i.e., kernel-layer policy enforcement engine or userland classification/rationing daemon) through various techniques as discussed below. In view of these various implementation options (each with attendant advantages and complexities), messaging memory is depicted in FIG. 2 and with respect to other embodiments herein as straddling the kernel-userland interface. However implemented, the messaging memory provides a precisely defined and deterministic communication interface that enables classification and rationing transactions to be split between a kernel-side requestor and user-land provider without compromising kernel security. As discussed below, the messaging memory may be used to implement other cross-border (kernel-to-user and vice-versa) transactions that facilitate the functional split between kernel-based control and counting operations (policy enforcement) and userland classification and rationing operations (policy definition and management).

Still referring to the classification/reclassification request submission shown in FIG. 2, a kernel policy enforcer writes a partial or complete copy of the subject packet into messaging memory 180 and optionally sets a flag to signal that a classification/reclassification request is pending (i.e., new request has been “posted”). In one embodiment, the userland daemon evaluates the messaging memory as part of a service loop (or in response to an event such as a software interrupt triggered by the kernel) to ascertain whether new classification requests have been posted. The userland daemon ascertains whether the subject packet is part of a new flow at 185 (e.g., by deriving a flow identifier from the port/IP-address/protocol 5-tuple and comparing the flow identifier against a daemon-maintained table of flow identifiers for previously classified packet flows). If the packet is part of a new flow (affirmative determination at 185), the daemon classifies the new flow and rations data usage to the flow (187) according to a service plan interactively defined within the mobile device (i.e., defined/selected via interaction with the user via the user-interface of the device) and reflected in a traffic filter matrix (also referred to herein as a service policy component matrix) maintained by or rendered accessible to the userland daemon. Design and implementation of the filter matrix (also referred to herein as a policy component matrix in which groups of constituent policy components form service policies and collections of service policies form a service plan) are discussed in greater detail below.

Still referring to FIG. 2, upon classifying and determining a data allocation (ration) for a new flow, the userland daemon writes a “verdict” to the messaging memory indicating the flow control policy to be applied to the subject packet (and subsequent packets of the same flow) together with a value that specifies, directly or indirectly, the rationed data usage. More specifically, in a number of implementations (discussed in greater detail below), the userland daemon preconfigures a number of data ration “buckets” (or flow meters) within the kernel against which individual or grouped packet flows are to be counted. Accordingly, upon classifying a new flow, the user daemon may indirectly ration data usage by specifying a bucket (flow meter) that is to be decremented from a predetermined initial data-ration value toward an eventual depleted state as packets associated with a given flow are allowed to propagate between the userland/kernel boundary and mobile-device PHY.

If the userland daemon determines that the packet submitted for classification/reclassification is not a new flow (e.g., flow ID found in classification history table in the evaluation at 185), the daemon views the kernel message as a reclassification request (e.g., triggered by bucket depletion) and either reclassifies the flow (e.g., establishing a new policy, which may simply be to block the flow), specifies an alternative data rationing (new bucket for metering data usage) or updates (tops-up or otherwise replenishes) the pre-existing data-ration bucket as shown at 189. As discussed below, top-up and other bucket management operations may be effected via messaging operations separate from the verdict-return message. Also, kernel-layer processing of verdict-bearing messages from the userland daemon may be implemented by kernel processes other than the policy enforcement engine—a split processing architecture that enables the policy enforcer to execute relatively deterministically, pushing classification/reclassification requests to userland and terminating (signaling packet stall, for example) without awaiting the userland response. Accordingly, a packet submitted to the policy enforcer at 151 may be newly presented or a re-try/resubmission of a previously presented (and stalled) packet.

Reflecting on FIG. 2, it can be seen that, for many packet flows, the vast majority of packets presented to the policy enforcer may be subject to pre-tabulated policy control and data-usage allocations, with userland assistance required only at the outset of a given flow (i.e., to classify and ration a new flow) and upon depletion of a rationed allocation. Accordingly, considering a given flow as a whole, secure, low-latency policy enforcement (control and counting) is effected predominantly within the kernel layer without exposing the kernel OS to the frequent updating and potentially multi-party development often needed to implement robust and agile classification and allocation functions. Moreover, designing the kernel-space policy enforcer to request reclassification upon bucket depletion provides a robust and flexible mechanism for enabling incremental userland control over packet flows. For example, where userland requires a particular packet or set of packets in a flow in order to complete a classification action, userland may respond to an initial packet in the flow by rationing sufficient allocation to trigger reclassification upon receipt of that packet of interest (e.g., rationing just enough data to trigger a reclassification request in response to the fourth packet of a TCP packet stream—i.e., the packet identifying the source/destination application in a packet flow initiated by generic SYN, SYN/ACK and ACK packets). Additionally, where userland desires incremental notification as a given data allocation is assumed, the userland daemon may specify an initial data ration that is a fraction of the overall allocation otherwise applicable to a given flow, thus forcing a reclassification request (and subsequent supplemental or alternative fractional allocation) as each fractional data ration is depleted. These collaborative metering operations are discussed in greater detail below. Also (or alternatively), the userland verdict may allow one packet to pass without creating a policy for the subject flow, causing a subsequent packet within the same flow to trigger another classification request and thereby enable packet-by-packet userland inspection until the daemon can classify the flow.

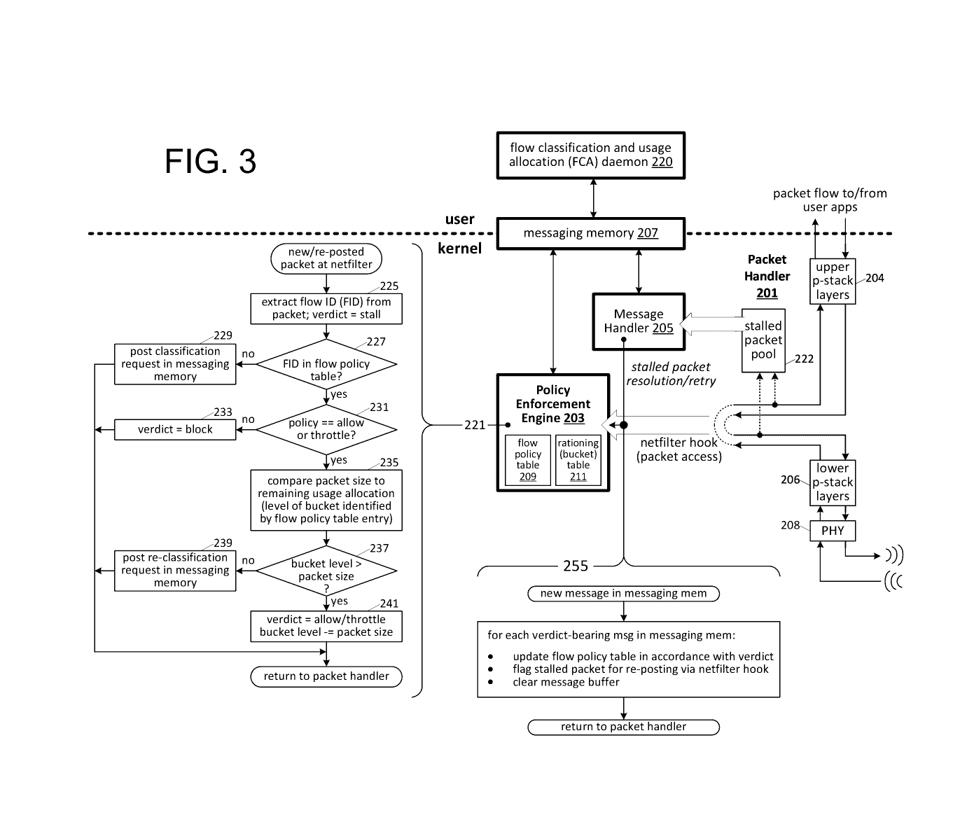

FIG. 3 illustrates exemplary interactions between and operations within a kernel layer packet handler 201 (including and/or spawning a message handling service, 205) and kernel-layer policy enforcement engine 203. As shown packets flow bidirectionally through upper and lower protocol-stack layers (204, 206) of the packet handler, with inbound packets being received via a wireless physical signaling interface 208 (e.g., radio and modem as discussed above) and propagating through the protocol stack to userland applications, while outbound packets flow in the reverse direction from the userland applications through the protocol stack to the physical signaling interface for wireless transmission. Between the lower and upper protocol layers, a netfilter hook provides packet access to the policy enforcement engine, for example, delivering a pointer to a netfilter data structure that includes a policy control field, pointer to the packet (i.e., in a zero-copy driver implementation), rate control field and other packet metadata.

In the implementation shown, policy enforcement engine 203 maintains a flow policy table 209 and bucket (data-rationing) table 211 and responds to packets posted by the netfilter as shown in detail view 221. More specifically, upon detecting (or being notified of or invoked in response to) a newly posted packet at the netfilter interface, the policy enforcement engine extracts the flow ID (“FID”) from the packet at 225 and initializes the verdict field within the netfilter data structure to “stall.” At 227, the policy enforcement engine applies the flow ID to the flow policy table to determine whether the flow has been classified. If the flow ID is not found in the flow policy table, the policy enforcement engine posts a classification request in messaging memory 207 (i.e., as shown at 229) and terminates, thus returning a “stall” verdict to the packet handler by virtue of the verdict initialization at 225.

If the flow ID is found in the flow policy table (affirmative determination at 227), the policy enforcement engine evaluates the policy within the flow-ID-indexed table entry to determine whether the packet is to be allowed (or throttled—which may be viewed as a rate-limited allowance). If not to be allowed (i.e., policy indicates block), the policy enforcement engine records the block verdict at 233 and returns to the packet handler, thereby signaling the packet handler that the packet (and thus the flow) is to be blocked.

If the indexed flow policy table entry indicates that the packet is to be allowed/throttled, a data-ration bucket (flow meter) specified by the flow policy table entry (i.e., particular bucket in the bucket table) is evaluated at 235 to determine whether the bucket level (i.e., remaining allocation) is sufficient to accommodate packet allowance (i.e., bucket level≧packet size). If sufficient allocation remains (affirmative determination at 237), the verdict is set to “allow” or “throttle” at 241 in accordance with the flow policy table entry and the bucket level is adjusted to reflect packet allowance, in this case decremented by subtracting the packet size from the current bucket level to yield the adjusted bucket level. The policy enforcement engine then terminates, effectively returning the allow/throttle verdict to the packet handler after counting the packet against the policy-prescribed data-usage allocation.

Returning to decision point 237, if the bucket level is insufficient to accommodate the packet, the policy enforcement engine posts a reclassification request in the messaging memory at 239 (e.g. copying the packet into the messaging memory as discussed above) and then terminates to return the initially established “stall” verdict to the packet handler.

In the embodiment of FIG. 3, classification/reclassification requests posted to messaging memory 207 are taken up asynchronously by a userland flow classification and usage allocation (FCA) daemon 220. Accordingly, to avoid stalling the packet handler or other kernel processes pending the nondeterministic userland response time, the packet handler occasionally invokes (or spawns, etc.) message handler 205 to determine whether userland daemon 220 has posted a new message or messages within messaging memory 207, executing the exemplary message handling sequence as at 255 upon affirmative determination. In the embodiment shown, for example, message handler 205 responds to each verdict-bearing message found in messaging memory 207 by updating flow policy table 209 within the policy enforcement engine to reflect the flow policy and any usage allocation specified in the verdict (i.e., acquiring the verdict from the message), re-posting the stalled packet or flagging packet handler to re-post the stalled packet (i.e., the stalled packet being identified by the message and maintained by packet handler 201 in stalled-packet pool 222) via the netfilter hook, and clearing the message buffer. By this operation, the message handler (or packet handler 201) will re-post the stalled packet for processing by policy enforcement engine 203, which, in view of the userland flow classification reflected by the newly inserted policy table entry, will now be found in flow policy table 209 and thus subjected to the tabulated flow policy.

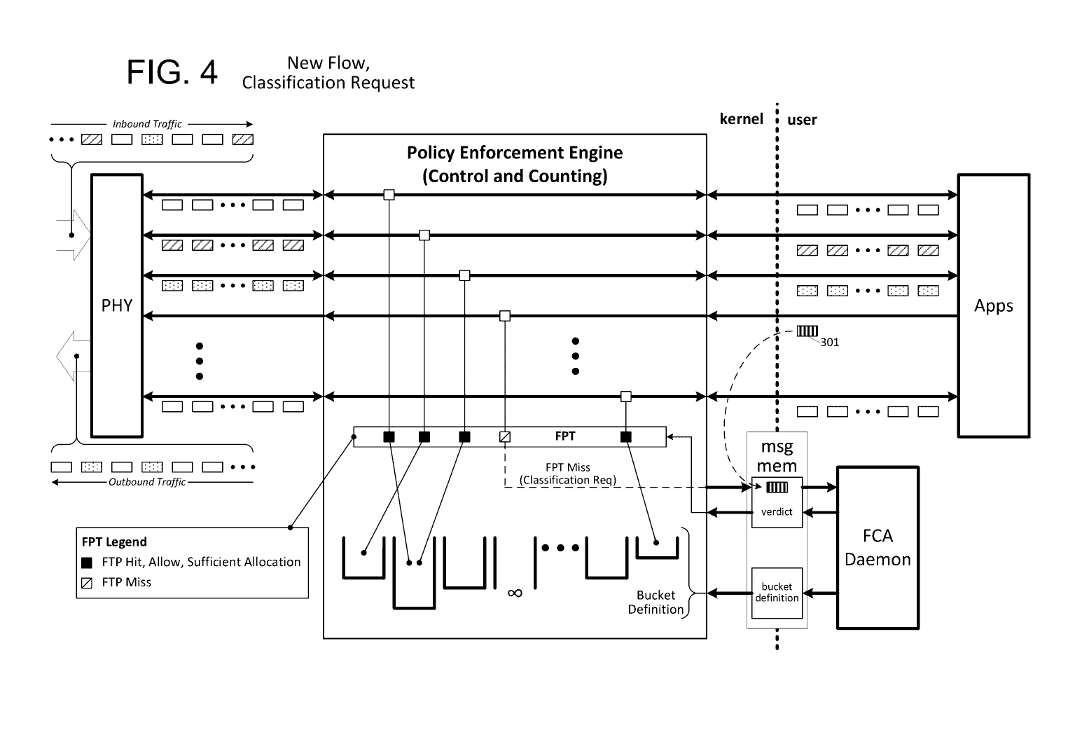

FIG. 4 illustrates a conceptualized packet flow between a physical signaling interface (PHY) and application processes (Apps) within a wireless mobile device. In general, packets corresponding to different logical flows (i.e., each logical flow being characterized by packets that, for example, share the same 5-tuple source/destination port, source/destination IP address, transport-layer protocol) are illustrated with respective shading/hashing (i.e., all packets with the same shading/hashing belong to the same flow) and, as demonstrated by the exemplary “inbound” and “outbound” traffic are randomly interspersed with one another. Thus, while depicted as traversing respective flow-dedicated paths between PHY and application processes, such paths reflect the uniform policy enforcement applied to the same-flow packets rather than separate physical pathways. More specifically, in the specific example shown, four of the five depicted flows are assumed to have been classified and data-rationed by the userland daemon discussed above so that as each new packet is presented to the policy enforcement engine, a flow policy table (FPT) “hit” occurs (i.e., flow policy for the subject flow is resident in the flow policy table), with the flow being metered (counted) within a pre-defined, FPT-specified bucket. Thus, beginning with the topmost flow, and referring to the FPT legend, a FPT hit occurs with respect to each constituent packet of the flow and incrementally decrements the corresponding policy bucket (the instantaneous level of which is represented by the level of gray-shading within the bucket outline). Each packet within the flow marked by cross-hatching (one flow below the topmost flow) also yields a FPT hit and is directed to the leftmost policy bucket as shown, and each packet within the third-from-top flow (dotted-packet) also yields a FPT hit, but decrements the same policy bucket as the topmost flow. As this shared-bucket arrangement demonstrates, the ability to meter a given flow out of any pre-defined policy bucket (i.e., data-ration) and to dynamically define additional buckets and/or supplement pre-existing buckets enables the userland daemon to flexibly ration data to various applications as necessary to meet virtually any service plan definition, including sharing a given data allocation between two or more network services, redistributing a net data allocation between services on the fly (dynamically) in response to immediate circumstances or user input, adding new data allocations in real time and so forth. Moreover, buckets may be defined with zero data allocation (empty bucket definition) to yield per-packet reclassification requests (and thus userland notification of particularly critical or malicious traffic) and with infinite data allocation, for example to accommodate a change in network state from a subscribed (pay-for-data-usage) network to an unpaid data usage network (e.g., transitioning from a cellular network to WiFi).

Still referring to packet flow examples shown in FIG. 4, an initial outbound packet 301 from a userland application yields a flow-policy-table “miss”, thus triggering a classification request from the policy enforcement engine. In the example shown, the subject packet is copied to an available message buffer within the messaging memory, thereby triggering delivery (writing) of a userland-generated flow classification and data-rationing result (i.e., verdict) within that same message buffer. In alternative embodiments, the FCA daemon (userland daemon) may write the verdict-bearing message (e.g., with a flow identifier) into a separate message buffer and/or the kernel-layer PE engine may copy only a portion of the packet that yielded the FPT-miss into the messaging memory (e.g., selected header fields and/or payload fields). Also, in addition to the bilateral transaction reflected by the classification request and verdict delivery, the FCA may initiate unilateral (directive) transactions, for example, to define new buckets or modify (e.g., top-up) existing buckets. Such bucket definition/modification directives may also piggy-back on or otherwise be integrated with verdict-bearing messages, for example, specifying that a new bucket is to be defined and that a newly classified flow is to be metered out of that bucket. In any case, the policy enforcement engine updates the flow policy table according to the userland verdict so that an unequivocal policy may be applied to packet 301 (which may be stalled pending the classification result as discussed above) and subsequent packets of that same flow.

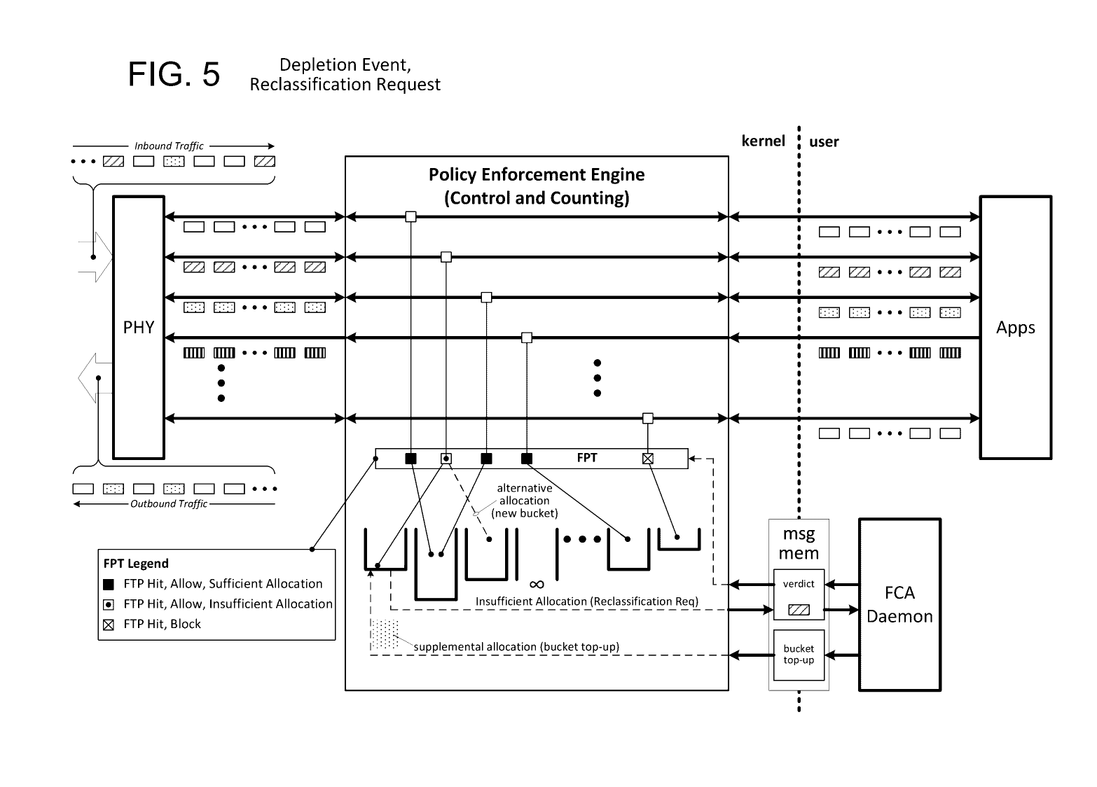

FIG. 5 illustrates a continuation of the packet flow shown in FIG. 4 after a data-ration allocated to the bottom-most flow has been depleted followed by a policy change from allow to block (i.e., policy change effected by a userland verdict rendered in response to a reclassification request). Moreover, the packet most recently presented to the policy enforcement engine from the cross-hatched flow has yielded a depletion event (i.e., insufficient data allocation remaining in the leftmost policy bucket from which the subject flow is metered). Accordingly, the policy enforcement engine has submitted a reclassification request to the userland daemon via the messaging memory and received (e.g., via the packet handler's message management service as discussed in reference to FIG. 3) a verdict. In this case, to enable continued flow, the verdict may specify that the subject flow remains allowed (or throttled) but identify a non-depleted bucket from which to meter—redirecting the flow to a different bucket. Alternatively, the userland daemon may direct the policy enforcement engine (or kernel-layer messaging service) to refill the depleted bucket to enable flow continuation—an operation referred to herein as a “top-up,” though the supplemental allocation to the otherwise depleted bucket need not completely fill the bucket (i.e., any supplemental allocation that permits passage of the packet that yielded the depletion event may be applied).

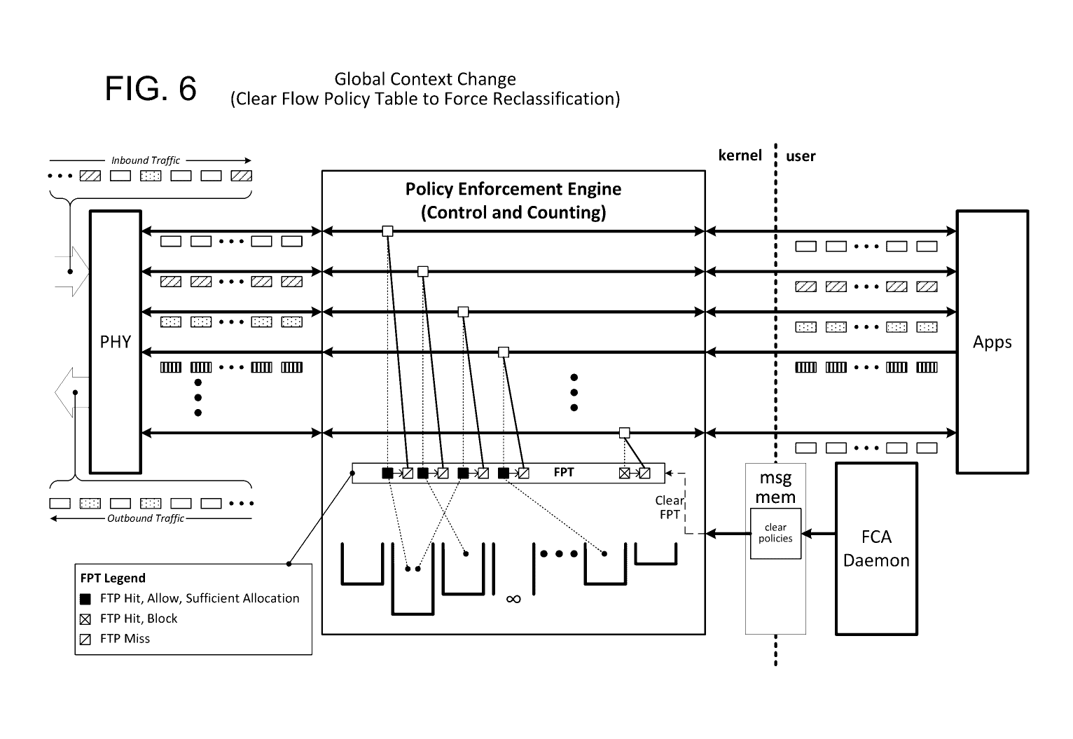

FIG. 6 illustrates a further continuation of the packet flow shown in FIGS. 4 and 5, in this case demonstrating a kernel-level policy-clearing operation directed by the userland daemon in response to a change in mobile device operating context—in this case, a change in device state, policy state, usage state, etc. that impacts all or at least multiple flow control policies, referred to herein as a “global context.” For example, upon detecting a transition from a subscriber-paid network (e.g., cellular network) to an unpaid network (e.g., WiFi)—a change in network state—the userland daemon may issue a policy-clear message to the policy-enforcement engine, causing the policy enforcement engine to clear previously loaded policies from the flow policy table (note that the buckets and their instantaneous levels may be left intact so that data-usage counts are undisturbed). By this operation, each packet of a given flow will, upon posting to the policy enforcement engine, trigger a classification request at which point the userland daemon may apply a new policy and data rationing flow by flow.

One advantage of the re-classification approach to global context change implemented in the embodiment of FIG. 6 is that the policy-enforcement engine may remain context agnostic. That is, the flow policy table may be indexed without regard to global context (or flow specific-context as described below) and thus limit table size and indexing latency.

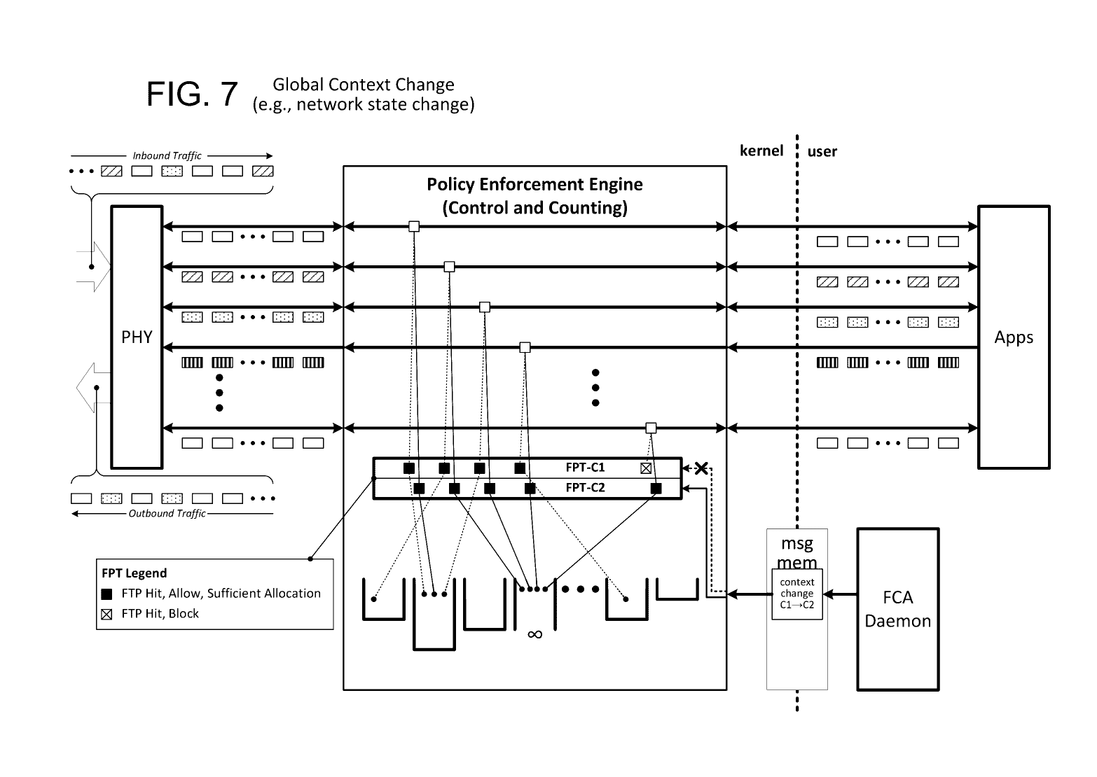

FIG. 7 illustrates an alternative (or additional) approach to managing global context changes that avoids the all-flow-reclassification approach shown in FIG. 6. In this case, the policy enforcement engine maintains a context-sensitive flow policy table—that is, a flow policy table that is indexed by a joint combination of the flow ID and one or more global context values. In the specific example shown, for instance, two different network states (e.g., one for subscriber-paid data usage and the other for unpaid data usage) correspond to respective global contexts (e.g., C1 for the subscriber-paid network and C2 for the unpaid network), each of which has a respective set of flow policies and policy bucket assignments. Continuing the paid and unpaid example, the flow policies for the subscriber-paid network context, C1, specify usage-limited data buckets for four of the five packet flows shown, and a block-traffic policy for the fifth flow. By contrast, the flow policies for the unpaid network context, C2 (e.g., WiFi), specify that an unlimited-usage bucket is to be shared by four of the five flows (including the flow blocked in the C1 context), while one of the flows continues to be metered out of the same bucket as in context C1. By this arrangement, when the user-daemon issues a global-context-change message, signaling a transition from C1 to C2 in this example, the policy enforcement engine records the new global context and thereafter indexes the flow policy table accordingly, following the policies and data-rationing assignments reflected in the lower half of the flow policy table (“FPT-C2”). While a transition between two sets of context-indexed flow policy table entries are shown, numerous such context-indexed entries may be implemented in alternative embodiments, including hierarchically ordered contexts such that, for example, M different context values each having one of N states may index one of N^{M} sets of flow policy table entries.

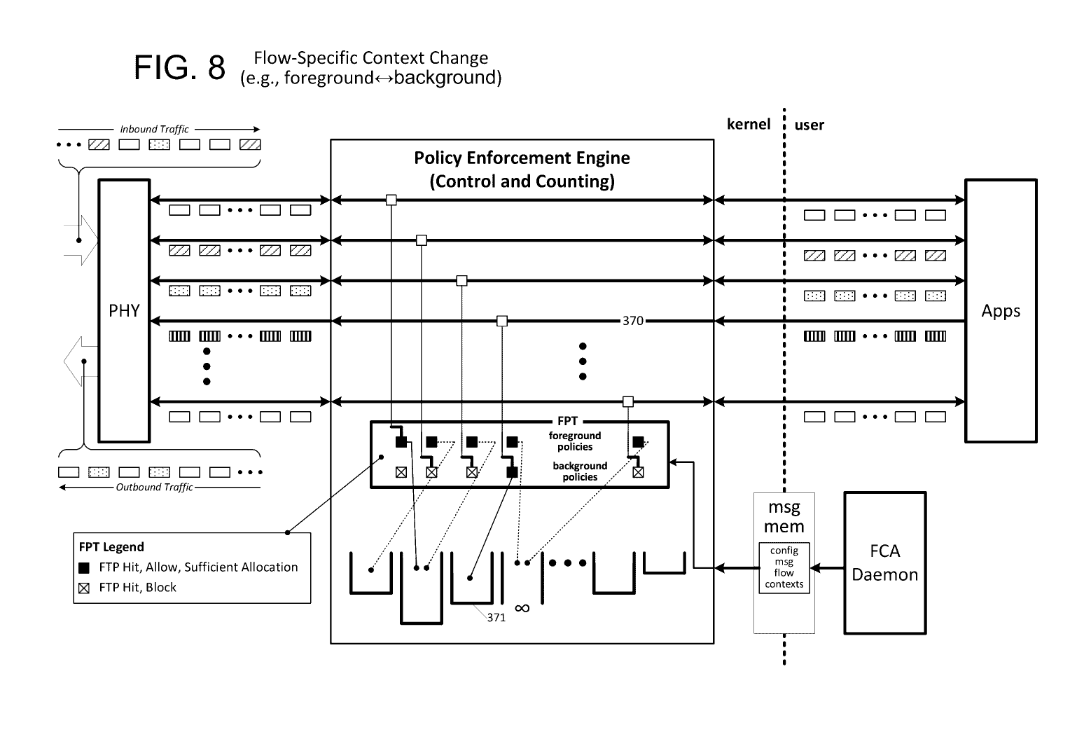

FIG. 8 illustrates a further policy enforcement example in view of the exemplary packet flow shown in FIGS. 4 and 5, in this case implementing a flow policy table that accounts for flow-specific contexts (e.g., attributes of specific flows and/or their network or user-layer destinations). More specifically, for purposes of example and without limitation, the flow-policy table is indexed, flow by flow, in accordance with the foreground/background status of the user-application to/from which constituent packets of that flow are destined/sourced. Of the five exemplary packet flows shown, all are subject to traffic-allow policies and metered out of shared or dedicated buckets while their respective user applications are executing in the foreground (e.g., as illustrated in the uppermost “foreground” row of the flow policy table). By contrast, four of the five packet flows are subject to traffic-block policies while their respective applications are executing in the background, and metering of the fifth packet flow (i.e., flow 370) is redirected from unlimited bucket to finite-allocation bucket 371.

Still referring to FIG. 8, the FCA daemon issues flow context messages to the kernel layer upon detecting flow context changes (e.g., transition of user application from background to foreground or vice-versa), supplying for example, the contexts of all flows in a given message, or only those whose contexts have changed. In either case, the policy enforcement engine applies the flow-specific contexts to index the appropriate policy for each flow. In the specific example shown, the user application corresponding to the topmost flow has been identified (by the FCA daemon via configuration message) as executing in the foreground, while the user applications corresponding to the other four flows have been marked as background operators.

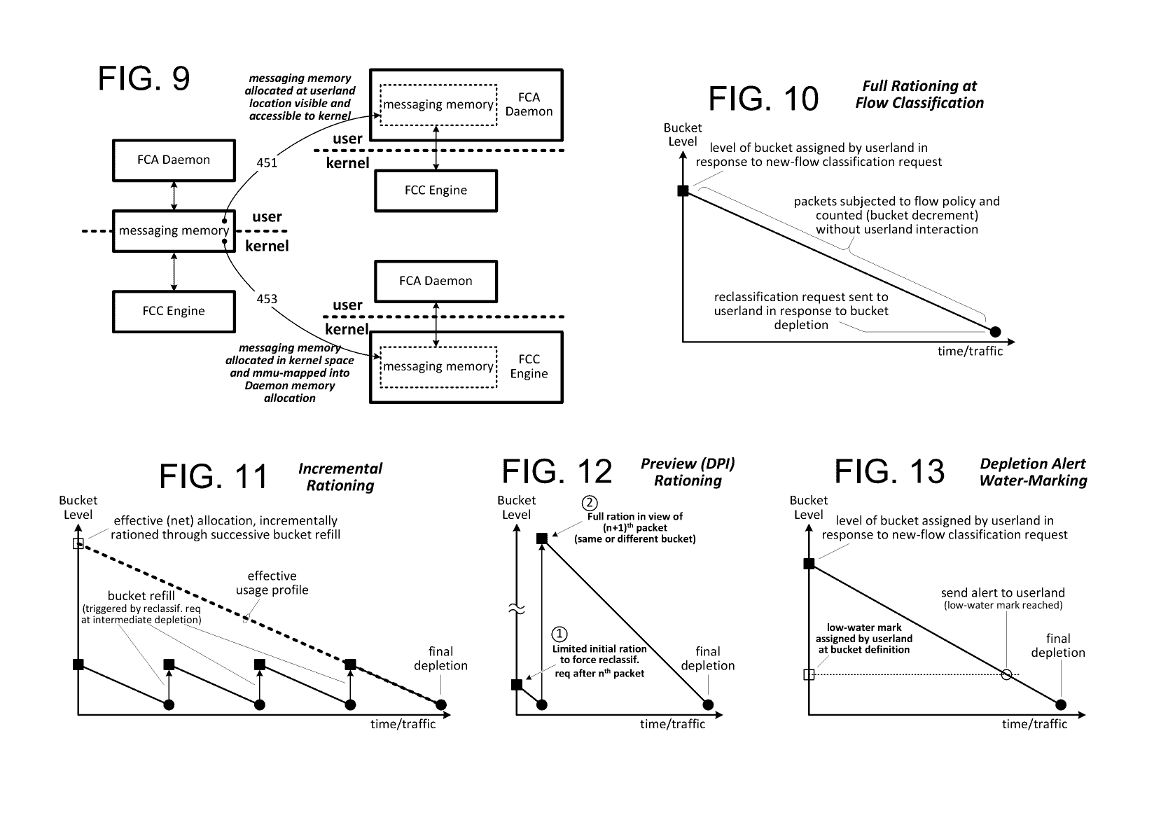

As discussed above and illustrated in FIG. 9, the kernel-to-userland messaging memory may be allocated either in kernel space or user space, with each allocation scheme having attendant advantages. In the case of user-space allocation, shown at 451, the unrestricted-permission set of the kernel permits kernel processes (e.g., policy enforcement engine and messaging service) to simply write into and read from the userland memory allocation (e.g., ascertaining the messaging memory address range from the kernel's record of the userland daemon's virtual memory allocation). One advantage of this approach relative to kernel-space mapping of the messaging memory is that no special permissions need be granted to the userland daemon, nor any exceptional memory mapping, thus making the user-land messaging memory allocation a potentially more broadly applicable approach (i.e., possible even in architectures that lack a memory management unit (MMU)—a hardware component that may otherwise be used to overlay (map) a portion of the userland daemon's virtual address space onto the physical messaging memory location within the kernel's restricted memory space).

Still referring to FIG. 9, allocation of the messaging memory in kernel address space (i.e., as shown at 453), while requiring a portion of the userland daemon virtual memory space to be exceptionally mapped onto the kernel-space messaging memory (e.g., using a MMU), may provide some security advantages. Also, because the kernel processes tend to be more stable and less prone to crash than userland processes (and even in the event of crash may be restored to a deterministic memory access allocation) messaging memory may be more persistent in a kernel-space allocation.

FIGS. 10-13 illustrate various network activity management functions made possible by the bifurcation of classification/data-rationing (policy definition) and control/counting (policy enforcement) functions between userland and kernel-layer processes, respectively. FIG. 10 illustrates a full-rationing example in which a full data allocation is rationed to a flow in response to a new-flow classification request (i.e., rationed by collaboration between userland daemon and policy-enforcement engine/messaging service as discussed above). As shown, after the flow has been classified and rationed, constituent packets of the flow are controlled (subject to the prescribed flow policy) and counted/metered without userland interaction until a depletion event triggers submission of a reclassification request. As discussed above, this approach enables the vast majority of packets within a given flow to be managed (controlled and counted) exclusively within the kernel.

FIG. 11 illustrates an incremental rationing approach achieved through successive allocation of fractional portions of a total available data allocation. In the particular example shown, for instance, approximately one quarter of a total available data allocation is allocated to a newly detected flow. Eventual depletion of that quarter allocation triggers a reclassification request to which the user daemon responds with a supplemental allocation, in this example, restoring the depleted bucket with another quarter allocation. By this operation, userland may control the frequency (from a data usage/data metering standpoint) with which depletion messages (classification requests bearing a previously classified flow ID) are reported by the kernel layer—an approach that may be beneficial for alert-based user reporting and for avoiding undue loss of metering data (e.g., battery pull just prior to conclusion of an extensive UDP packet stream).

FIG. 12 illustrates an approach similar to incremental rationing, but with the initial incremental ration limited (chosen) to force a reclassification after a predetermined number (N) of initial packets, thereby permitting userland inspection of the (N+1)^{th} packet at reclassification. As a more specific example, the initial ration may be chosen to permit passage of the first three packets of a TCP flow (i.e., the packets SYN, SYN/ACK and ACK that effect a three-way handshake for establishing the end-to-end TCP connection) and thereby permit userland inspection of the first packet that identifies the client application (i.e., an identifier discernable along with other information via deep packet inspection (DPI)). After the initial depletion/reclassification sequence, a full ration may be allocated in view of the N+1th packet, with rationing granted via the same or an alternative bucket (i.e., supplementing the same bucket or redirecting to a different bucket). Accordingly, through this incremental rationing approach, only those packets required for classification are exposed to the userland daemon, with subsequent flow contents (including potentially sensitive user and/or application information) being controlled and counted securely within the kernel-layer policy enforcement engine.

FIG. 13 illustrates another approach referred to herein as depletion-alerting or water-marking. In this case, one or more alert levels or low-water marks may be associated with a bucket and the policy enforcement engine modified to convey an alert message (e.g., via the above-described messaging memory) upon determining that the alert level (low-water mark) has been reached (or that the bucket level has fallen below the low-water mark). Through this approach, userland daemon may be alerted of an impending depletion event before event occurrence and thus alert the mobile device user (permitting the user to purchase, redistribute or otherwise provision additional data allocation to the near-data-exhaustion user process) or take other action to pre-empt the depletion event (e.g., automatically rebalance process-specific data allocations according to predetermined data balancing policies specified by the mobile device user or as a default device configuration).

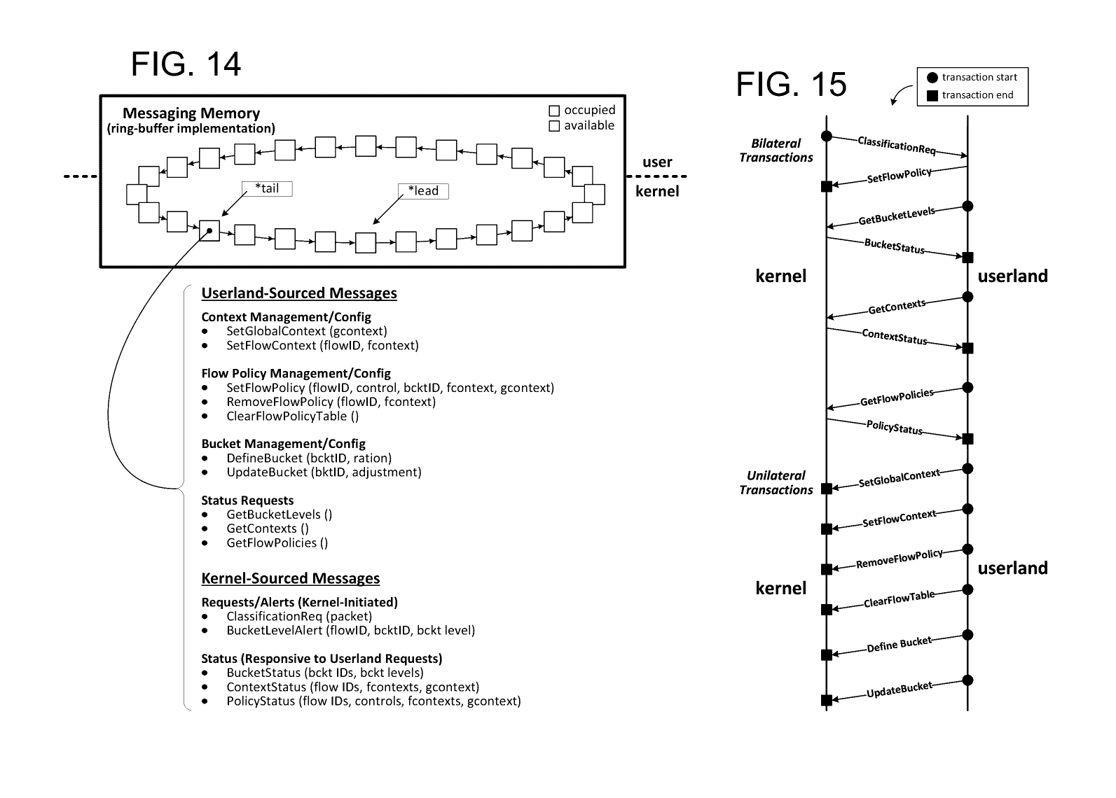

FIG. 14 illustrates an exemplary ring-buffer implementation of a messaging memory and examples of userland-sourced and kernel-sourced messages that may be conveyed via the messaging memory. In the embodiment shown, the ring buffer is formed by a circularly linked-list of message buffer elements each of which has a status, at any given time, of occupied (shaded buffer elements) or available (non-shaded elements). Though not specifically shown, each buffer element may have additional “metadata” attributes, including an indicator of the transmission direction (i.e., last entity to populate the buffer element, kernel process or userland process), timestamping, etc. In one implementation, pointers to the tail and lead buffer elements (*tail and *lead) that bound an occupied buffer-element sequence are maintained to enable rapid identification of extant messages (occupied buffer elements) and determination of the next available buffer element. One advantage of this approach is that the ordering of buffer elements between the tail and lead pointers corresponds to the sequence in which those buffer elements were loaded, thus permitting the receiving process (e.g., userland daemon in the case of classification/reclassification requests) to respond to the messages progressively from oldest to newest and thus in an order that minimizes worst-case response latency. Various other messaging structures may be used in alternative embodiments, and the number of buffer elements may be larger or smaller than that shown. Further, provisions for relocating buffer elements within the ring (e.g., unlinking a buffer element and inserting that buffer element between other buffer elements) may be provided in alternative embodiments, particularly where message-triggered actions require non-uniform and/or nondeterministic amounts of time. Similarly, while occupied message buffer elements are depicted as extending in continuity between tail and lead pointers, occupied buffer elements may be distributed in multiple discontiguous sequences (including a “sequence” of one buffer element) in alternative embodiments, with metadata provided to enable identification of occupied buffer elements.

Still referring to FIG. 14, userland-sourced messages include context management messages, flow policy management messages, bucket management messages and status-request messages. The context management messages include messages for setting one or more global contexts (conveying corresponding parameters “gcontext”), and for setting flow-specific contexts (conveying one or more flow IDs and corresponding flow contexts, “fcontext”). Flow policy management messages include messages for inserting a flow policy within the kernel-space flow policy table (e.g., passing a flow ID, policy control value, bucket identifier, and, if supported, flow-specific context and/or global context values), as well as messages for removing a given flow policy (e.g., specified by flow ID and, if implemented, flow-specific context value(s)), as well as a message for clearing the entire flow policy table. Bucket management messages include messages for defining new buckets as well as updating (replenishing or otherwise adjusting the level of) previously defined buckets. Status request messages includes messages that instruct the recipient kernel layer process (or processes) to return the level of extant buckets, context settings, and flow policy settings.

Kernel-sourced messages include classification request messages (which may also convey reclassification requests where the flow ID has previously been submitted to userland for classification) which pass a copy of the packet to be classified, as well as bucket alert messages that specify low-water-mark events by flow ID, bucket ID and remaining bucket level. Status messages are generally conveyed in response to userland requests and include bucket status (reporting the bucket levels and IDs of extant buckets), context status (reporting any pre-recorded global context values and flow contexts applicable to respective flow IDs) and policy status (reporting flow IDs and policy control settings together with flow-specific and global contexts, if implemented).

FIG. 15 illustrates non-exhaustive examples of bilateral and unilateral transactions that may be effected by posting one or more of the message types shown in FIG. 14. In general bilateral transactions are those in which a message receiving process in userland or kernel-space posts (directly or indirectly) a responsive message, while unilateral transactions may be executed by conveyance of a single message, generally from userland to kernel.

Examples of bilateral transactions include a classification request message conveyed from the kernel to userland that triggers, in response, a policy setting message (i.e., classification result) from userland to the kernel. Other examples include userland posting of various status messages and responsive messages from the kernel (e.g., userland message to get bucket levels drawing a bucket status message from the kernel, and similarly for contexts and flow policies).

Examples of unilateral transactions include directive messages from userland to kernel to set global or flow-specific contexts, remove flow policies, clear the flow policy table, and define or update rationing buckets.

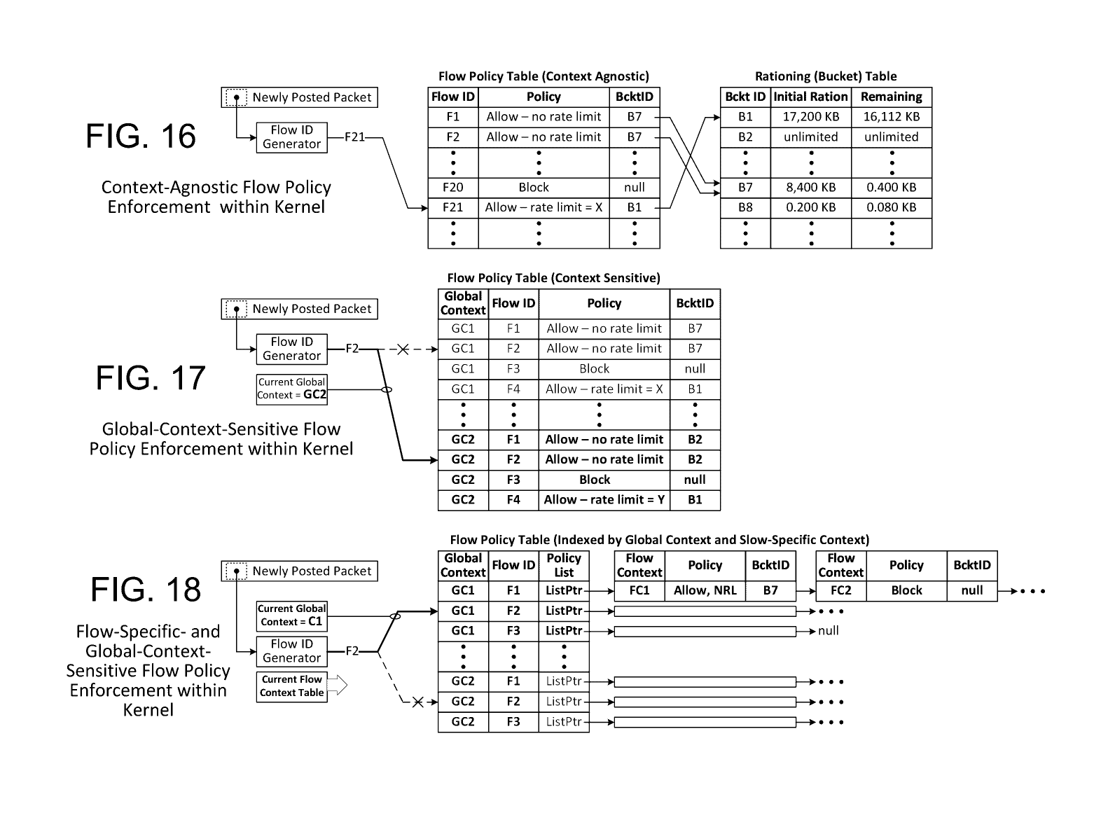

FIG. 16 illustrates exemplary embodiments of a context-agnostic flow policy table and corresponding bucket table (rationing table) that may be used to implement like-named tables within the policy enforcement engine of FIG. 3. As shown, one or more fields (e.g., 5-tuple) drawn from an incoming packet may be supplied to a flow ID generator to yield a flow ID that is applied, in turn, to index an entry within the flow policy table. The flow policy table entry contains a flow policy setting (e.g., allow without rate limit, allow with specified rate limit or throttle, block), and bucket identifier, with the latter pointing to the rationing bucket (i.e., indexing the bucket table) to be applied in an allowance of the incoming packet. In the exemplary implementation shown, each bucket table entry includes an initial data-ration field (i.e., showing the most recent bucket level setting supplied by userland) and a remaining-ration field, the latter indicating the remaining usage allocation. Although the bucket table entries are shown to further include respective bucket ID fields and the flow policy table entries are similarly shown to include respective flow ID fields, bucket ID/flow ID storage is not explicitly required (e.g., where the bucket ID and flow ID values are applied as address values to select specific entries in the bucket table and flow policy table, respectively.

FIG. 17 illustrates an alternative flow policy table that may be implemented to support kernel-level sensitivity to one or more global contexts. As shown, a global context is recorded within the kernel (e.g., in response to a userland-sourced context-setting message) and applied along with a packet-extracted flow ID to index a context-sensitive flow policy table. In the particular example shown, the global context setting is used to distinguish between different subsets of flow table entries, while the flow ID is applied to select a particular flow table entry within the context-specified subset. This hierarchy may be re-ordered in alternative embodiments (flow ID supplied as policy subset-selector, context applied to select policy within flow-ID-selected subset). The flow policy table fields (e.g., flow policy, bucket ID) may be implemented as described in reference to FIG. 16, as may the bucket ID table indexed by the bucket ID field of the flow policy table.

FIG. 18 illustrates an exemplary flow policy table implementation that enables policy resolution in view of both global and flow-specific contexts. In the embodiment shown, a flow ID and global context are applied as discussed in reference to FIG. 17 to select a particular policy table entry. Instead of directly indexing to a particular flow policy however, the flow ID/global context tuple yields a pointer to a linked list of flow-context policies, thus permitting non-uniform numbers of flow-specific contexts to be associated with different flows (i.e., without requiring expansive array definition). Various other data structures and/or indexing arrangements may be employed in alternative embodiments.

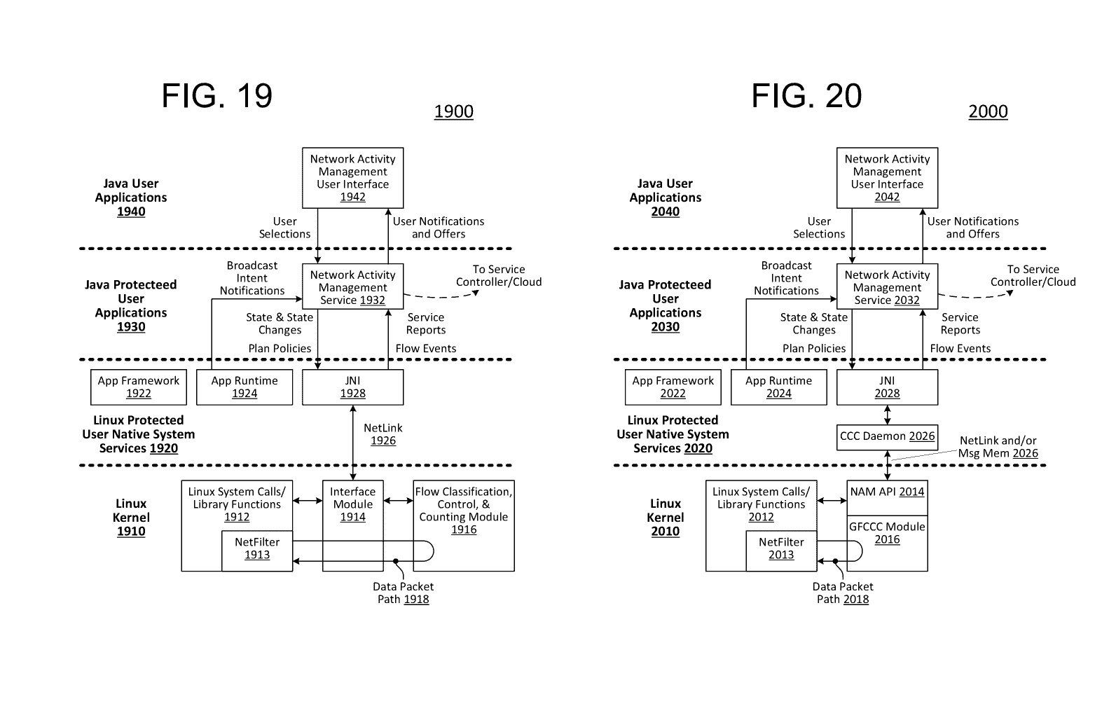

FIGS. 19-26 further illustrate how a mobile end-user device may implement or assist in implementing the policies implied by a particular end-user's selection of plan(s) and personal plan priority options. The depicted examples may be deployed in combination with and/or as alternatives to the various approaches discussed in reference to FIGS. 1-18. Also while the examples in FIGS. 19-26 illustrate embodiments operating on a Linux/Android operating system (OS) software platform, the concepts illustrated are readily adaptable to mobile end-user devices with other operating systems. As to the mobile end-user device hardware platforms on which the software platform runs, a typical applicable hardware platform may include the various components discussed above in reference to FIG. 1, including a processor comprising one or more general-purpose microprocessor cores and one or more specialized cores (graphics, image pipeline, codecs, etc.), registers, and caches, non-volatile memory to store code and data, random-access memory to hold executing application and OS code and data, a wired or wireless power connection point to charge the device and/or provide a wired data connection, a display screen to display graphics and video, audio playback speakers and/or headphone output, a microphone for audio input, tactile inputs such as one or more physical buttons, a fingerprint reader, and/or a touch screen sensor, camera(s), GPS receiver, motion sensor, a SIM (subscriber identification module), a WWAN (wireless wide-area network or “cellular”) radio/modem operating according to one or more known cellular technologies, a WLAN (wireless local-area network or “WiFi”) radio/modem, a Bluetooth radio/modem, and a NFC (near-field communication) radio/modem. Although not every applicable device need include each of these hardware elements, and reasonable substitutes for some elements either exist or will exist in the near future, those skilled in the art will recognize and generally understand the hardware elements necessary to complete various device functions explained in the embodiments below.

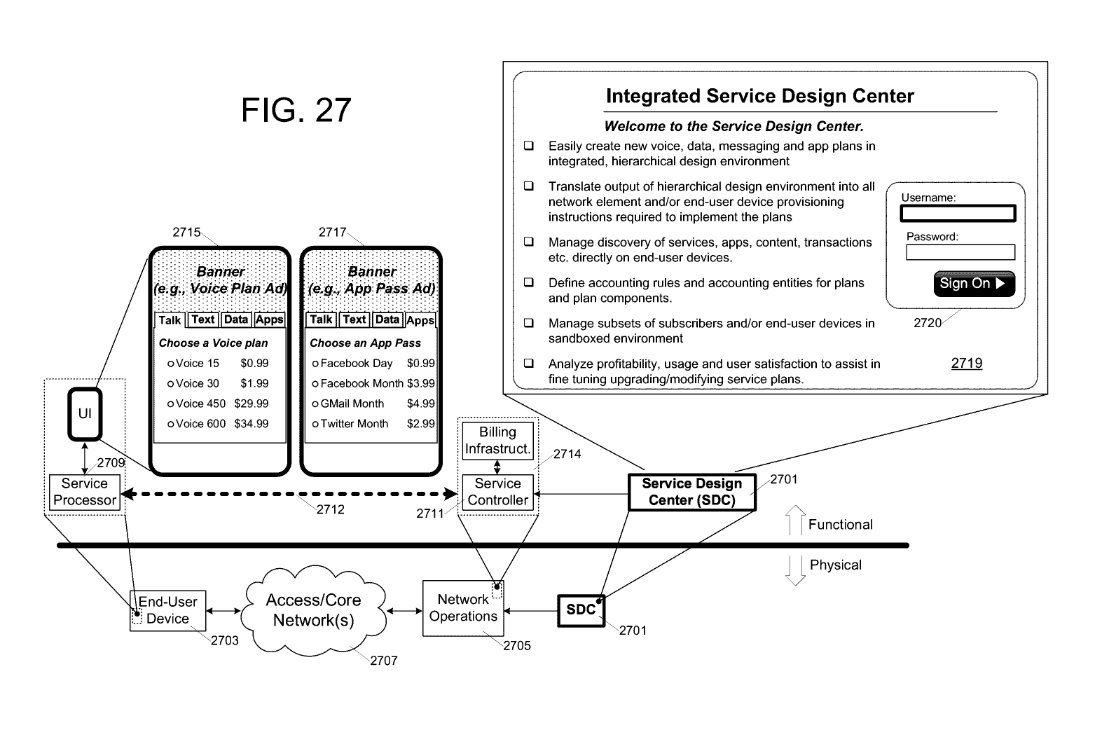

FIG. 19 illustrates, within an abstraction 1900 of a typical Android/Linux execution environment, modular portions of service processor software for implementing the mobile end-user device portion of various network activity service plans and policies described below with reference to FIGS. 27-34. Abstraction 1900 includes four runtime environments—a Linux kernel 1910, Linux protected user native system services space 1920, Java protected user application space 1930, and Java user application space 1940.

The Linux kernel 1910 includes modules for process scheduling, interprocess communication, memory and virtual memory management, security, and networking, and provides system calls 1912 to basic OS functions and hardware drivers. Of particular interest for network activity management is a set of system calls to the networking component shown as Netfilter 1913. As discussed above, Netfilter 1913 provides a set of hooks into selected points in the kernel's network stack. Kernel modules can register callback functions such that each packet reaching a particular hook can be examined and processed by a registered kernel module.

The kernel manages all other functions and processes that are not part of a kernel module in “user mode,” each process in its own execution environment or “sandbox.” Within a sandbox, a process (or in some circumstances, several related processes) are provided with (within virtual memory space) a code space and data space that are isolated from the code space and memory space sandbox of each other process. Each process has a user identifier (UID) assigned to the particular app or service running in that process, and each UID has designated permissions and execution priorities that are controlled by the kernel. Applications cannot interact with each other or access most system services without a specific permission to do so, enforced by the kernel. In later Android versions, SELinux (Security Enhanced Linux) enforces access control over all user mode processes, including processes running with superuser (aka “root”) privileges, by each process in a defined control domain and specifically authorizing the use of any services outside of that domain.

Linux protected user native system services space 1920 include various binary libraries, start-up services, and daemons that are part of the OS and run as root processes. In Android, these include the application framework 1922 and application runtime environment 1924 utilized by Java applications. Netlink 1926 provides a messaging interface for IPC between kernel space and user-space processes. The user cannot add, delete, or replace modules that run in space 1920, or in general change the privileges of modules that run in space 1920. Whatever entity controls the OS may, however, modify modules that execute in this space with OTA (over-the-air) verifiable updates, and may, in some circumstances, allow trusted third parties to modify their modules that execute in this space.

Java applications can run in either space 1930 or 1940, depending on their permissions. Java applications that are controlled by the OS control entity may be allowed to run in protected user space 1930, while the user is generally free to select the applications that run with normal user permissions in user space 1940.

The mobile end-user device network activity management (NAM) system is composed of four components in this example: a Java-implemented network activity management user interface (UI) 1942; a Java-implemented network activity management service 1932; a kernel interface module 1914; and a kernel flow classification, control, and counting module (FCCC) 1916.

NAM UI 1942 allows the device user to view their selected plans and plan status, set any user-optional features of those plans, and browse and select new plans. UI 1942 also notifies the user when one of the service policies triggers a notification action. Data for the display is received from the NAM service 1932, and any user selections from NAM UI 1942 are forwarded to NAM service 1932 for appropriate handling.

NAM service 1932 operates as a protected user application, and orchestrates the activities of all four NAM components based on plans and policies received from a cloud-based service controller over a secure service control channel. NAM service maintains a snapshot of relevant network and device state, and data regarding current service plans and service plan usage, including any user preferences that affect application of the policies. Whenever the user updates a plan or a plan option, or a plan expires or renews, for example, NAM service 1932 recompiles the current set of service plans and policies into a new classification filter matrix. The filter matrix contains all filters applicable to device traffic (including control, notification, and accounting filters), and indicates which filters are active for each possible set of device and network state. Whenever the filter matrix is recalculated, NAM service 1932 pushes the matrix, through Java Native Interface (JNI) 1928 and Netlink 1926, to kernel interface module 1914, which relays the matrix to flow classification, control, and counting module 1916.

In Android, NAM service 1932 registers to receive Broadcast Intents that indicate relevant network and device state and changes to state. For instance, NAM service 1932 may base policy on network state variables such as whether the cellular radio is active, whether a current cellular network connection is home or roaming, the type of cellular network connection (2G/3G/4G, etc.), the Access Point Name (APN) in use for Internet connection, whether a WiFi connection is active, whether the WiFi connection is free or incurs data charges, etc. NAM service 1932 may base policy on device state variables such as whether the user is interacting with the device, the priority of a process (e.g., whether it is a foreground process, a visible or otherwise perceptible process, an OS versus a user process, a background process, etc.), battery or power state, etc. As the particular state variables available may be device, operating system, and/or service provider dependent, NAM service 1932 generally collects available state information and distills the information into the type of state specified in the policies defined in the service center. The distilled information is transmitted, upon any relevant state change, to the kernel modules.

NAM service 1932 receives service usage updates from the kernel modules. Depending on configuration and potentially plan-dependent, service usage accumulated by the kernel modules for each applicable plan is reported to NAM service 1932 every X MB, every Y seconds, etc. (finer-grained information, such as per-application usage, in and out of plan, may also be reported). NAM service 1932 may use device service usage information to update the service controller with current usage information, reconcile device service usage information with network service usage information, update displayed information for NAM UI 1942, pop user notifications on NAM UI 1942, recalculate the filter matrix if necessary, etc. NAM service 1932 also may perform other functions not salient to this disclosure, such as administration and authorization with the service controller components.

Interface module 1914 could, in some embodiments, be merged with flow classification, control, and counting module 1916. Its status as a separate module forms a convenient point to identify all communications between NAM service 1932, module 1916, and kernel system calls 1912, and more readily update the NAM system for idiosyncrasies of different OS, OS versions, and OS builds. Interface module 1914, in the current example, provides the callback routines for a Netfilter 1913 hook that causes the module to receive memory pointers to each packet (and other packet information) as the packets reach a particular point in the network stack. The interface module 1914 may pass these pointers directly to FCCC module 1916, create other pointers into particular portions of the packets or related information, or possibly copy packet information to other memory structures. Thus module 1914 creates at least a virtual data packet path loop 1918 through FCCC module 1916.

Flow classification, control, and counting module 1916 performs the low-level packet inspection and manipulation necessary to implement the active service policies of the NAM system. As discussed above, NAM service 1932 pushes filter matrices and state information to FCCC module 1916. In one embodiment, the filter matrix includes at least one entry for each combination of user ID (associated with an application) and relevant state permutations that cause a different filter action to be applied to flows associated with that UID. As new applications are launched, the NAM service may push additional filter entries for those applications to the FCCC module as needed, and as a housekeeping measure the NAM service may instruct the FCCC module to delete entries that map to killed processes.

As new packet flows are observed in packet path loop 1918, FCCC module 1916 classifies the flows, e.g., by identifying the application (e.g., user ID) associated with the flow, a network endpoint at the far end of the flow, and/or other identifying information. Once classified, the flow is assigned to a flow table, which associates a flow identifier (such as the 4-tuple of source port, source address, destination port, destination address) with a classification identifier. The classification identifier can then be used for subsequent flow packets, and combined with current state information to index into the filter matrix. The filter matrix elements indicate control, notification, and accounting actions to be taken for each packet in the flow.

Exemplary control actions for a filter element include block flow and allow flow. In addition to indicating to Netfilter whether a packet should be blocked or allowed, FCCC module 1916 may also be tasked with further activities for a blocked flow. For instance, if a remote endpoint transmits a TCP/IP SYN packet to open a connection with a local application, but such a connection is blocked by policy, FCCC module 1916 may create a NACK packet, addressed to the remote endpoint, and inject the packet into the stack, to discourage the remote endpoint from repeated attempts to communicate with the disallowed application. Similarly, an attempted remote connection by a local application could be blocked and a spoofed NACK returned to the local application. The FCCC module may also modify packets, e.g., if an existing flow is to terminate by policy, for instance to signal FIN to close a TCP/IP connection. One or more filter elements may describe whether to block or allow packet flows when a flow's classification identifier does not match a more specific rule.

An accounting action can also be tied to a filter element. The FCCC module can be instructed where, amongst an internal counter array, to account for traffic allowed by a filter element. As each packet matching that filter is processed, the appropriate traffic counter is adjusted for the data length of that packet. Different matrix entries can point to different pointers. For instance, a Facebook traffic flow may be counted to one of two different buckets, in dependence on whether a WWAN connection or a WLAN connection is used for the traffic flow.

At least a portion of a notification action can also be specified in the filter matrix. For instance, a filter entry that blocks a particular application's flow may also state that when such a flow is blocked the event will be reported to NAM service 1932. A notification action can also be specified based on an accounting action—if an internal counter array element reaches a preset level, for instance, that event will be reported to NAM service 1932.

From the above description, several observations can now be made. First, FCCC module 1916 is particularly designed for the specific features needed by the NAM service and tightly integrated with the application 1932. As new features are added to the system, such features are likely to require changes in FCCC module 1916, and the FCCC module 1916 is not usable by any other service. Further, FCCC module 1916 is complex because of all the classification cases that it handles, and it enjoys kernel privileges, so there is a danger of damage to the running system software if FCCC module 1916's memory management were to, for example, go awry. The architecture detailed below takes a different approach to providing a NAM service, wherein a simpler and more generic packet handler with a standard API is supplied as a kernel module (or potentially as a core feature of the kernel). The particularities of service plans and policies reside in protected user space, and leverage the low-level functionality of the packet handler kernel module. The standard API limits the ways in which any NAM service could affect the kernel.

FIG. 20 illustrates, within an abstraction 2000 of a typical Android/Linux execution environment (an identical environment to abstraction 1900 of FIG. 19), modular portions of service processor software for implementing the mobile end-user device portion of the type of network activity service plans and policies described below with reference to FIGS. 27-34, but in this embodiment with a generic flow classification, control, and counting (GFCCC) module 2016. Abstraction 2000 includes the same four runtime environments as abstraction 1900, labeled as a Linux kernel 2010, Linux protected user native system services space 2020, Java protected user application space 2030, and Java user application space 2040. Several other elements can be essentially identical to those of FIG. 19, including the Linux kernel Linux system calls/library functions 2012 (with Netfilter functions 2013 particularly called out), application framework 2022 and application runtime 2024, JNI 2028, and NAM UI 2042. NAM service 2032 could, in some embodiments, be extremely similar to NAM service 1932, except its classifier communications are now exchanged with a classification, control, and counting (CCC) daemon 2026 instead of with a kernel interface module.

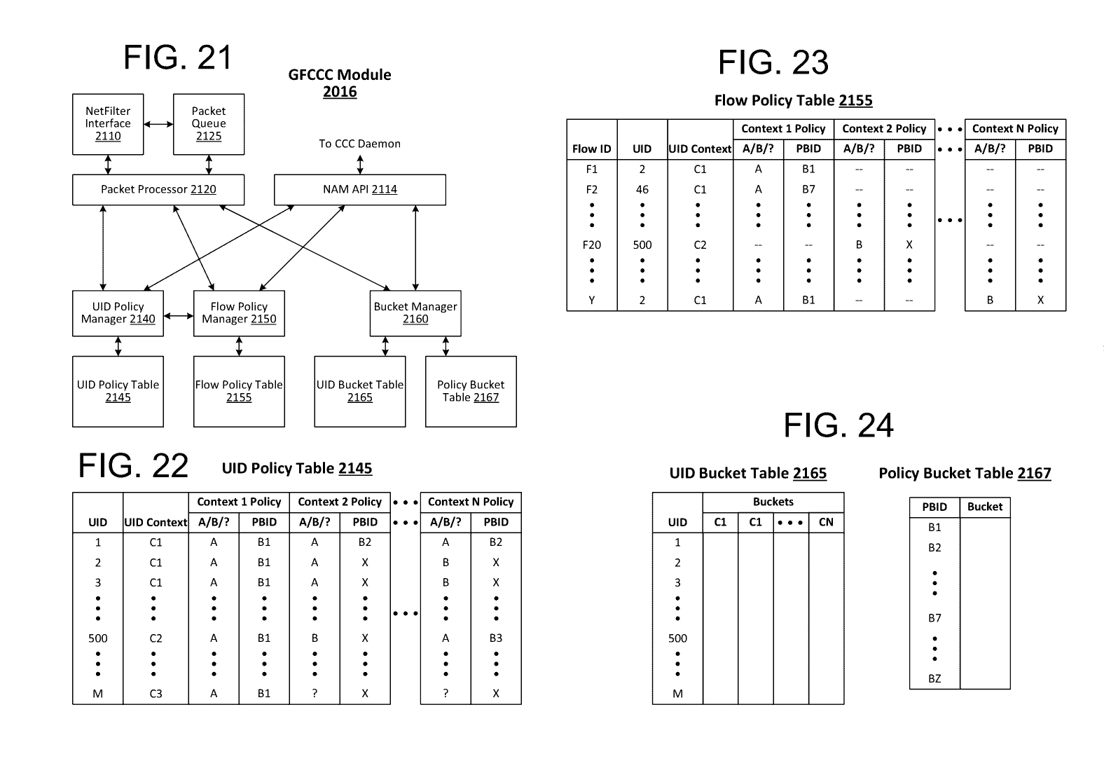

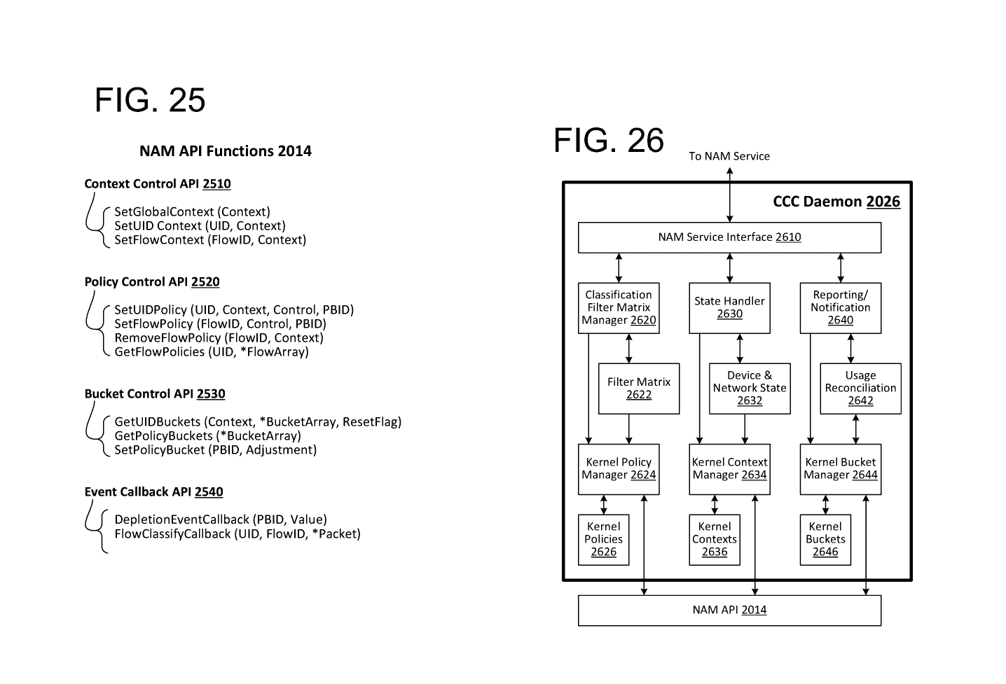

The new portions of FIG. 20, as compared to FIG. 19, are the CCC daemon 2026, a NAM API 2014, and the GFCCC kernel module 2016. GFCCC 2016 is explained with further reference to FIGS. 21-24, NAM API 2014 is explained with further reference to FIG. 25, and CCC daemon 2026 is explained with further reference to FIG. 26.

FIG. 21 illustrates the major components of GFCCC kernel module 2016 and the connections to NAM API 2014. These components include a Netfilter interface 1210, a packet processor 2120 and packet queue 2125, a UID policy manager 2140 and UID policy table 2145, a flow policy manager 2150 and flow policy table 2155, a bucket manager 2160, and a UID bucket table 2165 and policy bucket table 2167. Briefly, the Netfilter interface 2110 handles Netfilter system calls and callbacks to populate packet queue 2125 and handle Netfilter requests from packet processor 2120. Packet queue 2125 contains, in one embodiment, a linked list of packet pointers for packets in active processing or awaiting processing by packet processor 2120. Packet processor 2120 performs packet classification, control, and counting according to the configuration of tables 2145, 2155, 2165, and 2167, with the ability to query CCC daemon 2126 for unresolved flow classification cases. UID policy manager 2140 manages the contents of UID policy table 2145 and performs queries on those contents for other components. Flow policy manager 2150 manages the contents of flow policy table 2155 and performs queries on those contents for other components. Bucket manager 2160 manages the contents of UID bucket table 2165 and policy bucket table 2167, and performs queries on those contents for other components.

The following specific example assumes that the GFCCC module can be programmed with several global, UID-specific, and flow-specific contexts for efficiency. Three contexts are shown for illustration, but the specific number of contexts supported is design-dependent, based, e.g., on available memory resources. With pointer linked lists of context policies, different UIDs could even have different numbers of stored policies. Alternately, a single context per UID could be supported by an embodiment, and the CCC daemon would reprogram the GFCCC tables as needed for each context switch of a UID. Also, a UID policy manager and table is an optional element intended to reduce some communication between the GFCCC module and the CCC daemon, for easily resolved flows. As an alternative, all new flow classification tasks could be passed up to the CCC daemon and no default policy could be stored per UID.

FIG. 22 illustrates one configuration of a UID policy table 2145. Although shown as a two-dimensional table for illustration purposes, those skilled in the art will immediately recognize that various programming structures lend themselves to many-dimensional structures with better search, compactness, memory management, and/or fast access. In Linux/Android, a unique UID is assigned to each app or service; in this example, this UID is assigned one or more per-app policies. Thus when the UID policy manager accesses a particular UID entry in table 2145, the manager can retrieve the current UID context for that UID, and one or more per-context policies. The UID context is a generic value assigned by the CCC daemon—the CCC daemon can assign values as it sees fit. In some embodiments, one or more reserved UID context values can also be assigned to have shortcut meanings, such as “no policies assigned to this UID.” The CCC daemon could assign other context values as it sees fit; for instance, C1 could mean an unmetered WiFi connection, C2 could be a home WWAN 4G connection with the app not in foreground, and CN could be a roaming WWAN 4G connection with an app in foreground. These meanings could also be dynamically assigned by the CCC daemon if it has some way of tracking the intended meanings.

For each context, a control policy (“A/B/?”) and a policy bucket ID (PBID) are identified. A control policy setting of “A” for the current context indicates that a new flow requested by that UID is allowed, subject to their being a sufficient data allotment in the corresponding PBID. If the PBID is an “X” (don't care) value, then there is no PBID restriction for a new flow initiated by that UID. A control policy setting of “B” for the current context indicates that a new flow requested by that UID is blocked. Finally, a control policy setting of “?” means that for the current context a new flow requested by that UID should be sent to the CCC daemon for flow classification. Note that multiple UIDs may draw from the same PBID, and a UID may draw from different PBIDs in different contexts.

FIG. 23 illustrates one configuration of a flow policy table 2155. Flow policy table 2155 is similar in many ways to UID policy table 2145. Table 2155 is, however, arranged by flow ID. For each flow ID in the table, a flow ID entry contains the UID associated with that flow ID, the current context for that flow ID, and one or more per-context policies. Each policy can either be “A” (allow) or “B” (block). When a PBID is associated with an allowed flow ID in the current context, packet transmission is subject to their being a sufficient data allotment in the bucket associated with that PBID. Because flow policies are only needed for existing flows and for the contexts in which they exist, many flows may only have a single context populated in table 2155. Longer-lived flows may persist in multiple contexts, and thus could have multiple context policies, as shown for flow Y. Each entry may be rearranged in a linked list upon use such that older entries migrate to the bottom of the list and may be culled to make room for new flow entries. As another management scheme, normally terminated flows could be detected as an event that causes the corresponding flow entry to be deleted.

FIG. 24 illustrates one configuration of a UID bucket table 2165 and a policy bucket table 2167. A bucket table is an array to hold counter values. The UID and PBID columns shown in FIG. 24 may not exist in practice, as the ID may simply be used to index into a proper location in the table. UID bucket table 2165 is optional, but convenient, as it allows the system to maintain running counts of data traffic used by each UID in each context. This data could be used, e.g., to detect usage that is not per policy, suggest better data plans to the user, show the user their usage history, or reconcile with other usage sources. Policy bucket table 2167 is used to enforce usage limits for usage-limited policies, or to set checkpoints at which the system would like to know that a certain point in that policy usage has been reached. When a flow is associated with a policy bucket, allowed packets from that flow are counted against that policy bucket, and when the policy bucket contains an insufficient data allotment for a packet, a deficiency event can be declared. The deficiency event could simply drop packets from that flow until an additional allotment is added to the policy bucket. In a different configuration, the deficiency event is signaled up to the CCC daemon, which may then choose to (A) increase the allotment in the policy bucket, (B) change the policy for one or more flows affected by that bucket to use a different bucket, and/or (C) change the policy for one or more flows affected by that bucket to block those flows. When the deficiency event is signaled, one or more packets in the affected flow(s) could be queued while the deficiency event is resolved. The CCC daemon may intentionally allot small increments from a much larger plan allowance to a policy bucket, such that the CCC daemon can be alerted when that plan is being used. The “deficiency” is thus merely a checkpoint, and the CCC responds by topping up the policy bucket with a new micro-allotment.

Packet processor 2120 seeks to classify new flows, allow or block packets for those flows, and account for data usage. When a packet is received, packet processor 2120 queries the flow policy manager with the flow ID—if a corresponding flow ID entry exists, the current context, UID, allow/block policy, and any PBID are returned to processor 2120. If a corresponding flow ID entry does not exist or no policy entry exists for that flow ID and context, packet processor 2120 indicates either no flow ID entry, or no flow ID entry for the current context.

When packet processor 2120 is given a policy and context for the current packet, and the policy is “allowed,” processor 2120 queries the bucket manager 2160 for the current allotment in the PBID (if a PBID is indicated). If, looking at that allotment and the data length of the packet, a sufficient allotment exists for the packet, the packet is transmitted, the UID bucket for the packet's UID and context are incremented for the packet data size, and the allotment in the PBID is adjusted for the packet data size (in one embodiment, the adjustment is a subtraction and a depletion limit for the bucket is zero; in other embodiments, the bucket could count up towards an upper limit, potentially set on a per-bucket basis). If no PBID is indicated but the policy is “allowed,” the packet is transmitted, and the UID bucket for the packet's UID and context are incremented for the packet data size. If the policy is “blocked,” the packet is removed from the queue; other optional actions such as counting blocked packets per UID and/or spoofing connection refusals could also be performed in such a case.

When packet processor is not given a policy by flow policy manager 2150, it assumes that the flow requires classification (at least for the current flow context). It queries UID policy manager 2140 with the UID associated with the packet. If the UID policy table has an entry for the UID and current context, manager 2140 returns the policy to the flow packet processor. If the policy is not “?,” the packet processor asks the flow policy manager to store the policy for the current flow and context, and then processes the packet per that policy, as described above. When the policy is “?,” the packet processor stalls the packet and signals the CCC daemon to classify the packet. When the CCC daemon has classified the packet, it sets the appropriate flow policy, at which point the packet processor can handle the stalled packet. Note that in some circumstances, the CCC daemon may require more than one packet to perform the classification. In this event, it can instruct the packet processor to send the packet and save the usage, without assigning a policy to the flow. The CCC daemon will then continue to receive packets for the flow until it performs a classification. Packet processor 2120 may have some limit on unclassified packet flow length to prevent a rogue CCC daemon from examining an entire flow.

FIG. 25 shows an exemplary set of API calls implemented by NAM API 2014. The exact signaling mechanism underlying the API is a design choice, with several types of interprocess communication being candidates, again depending on the OS type. For the API to be secure from misuse, some safeguards should be employed such that only an authorized and verified CCC daemon can use the API functions. The API calls are divided into four subgroups: a context control API 2510; a policy control API 2520; a bucket control API 2530; and an event callback API 2540.

Three functions are shown in the context control API subgroup 2510 (it is again noted that some embodiments may not implement policy context switching in the kernel). The SetGlobalContext call instructs the GFCCC module to set the current context, for all UIDs and flows, to an indicated context. This could be useful, for instance, when the user is not actively using the device (and thus all UIDs could be said to be in the same context) but the device is being moved between different network connections. The SetUIDContext call, on the other hand, can be used to change the context of specific UIDs (and their flows), for instance, as the applications associated with those UIDs go in and out of the foreground of user interaction. Finally, the SetFlowIDContext call can be used to change the context of a single flow, for instance a stream or background download.

Five functions are shown in the policy control API subgroup 2520. The CCC daemon can use the first four of these functions to set and remove specific policies for specific UIDs and flows. Such actions are generally needed at boot time, or when a user's service plan status changes. The fifth function, GetFlowPolicies, is used by the CCC daemon to view the active flow policies associated with a specific UID. This function can be useful as the CCC daemon is not otherwise notified when the packet processor in the GFCCC module sets a flow policy based on a UID policy.

Three functions are shown in the bucket control API subgroup 2530. The GetUIDBuckets call allows the CCC daemon to retrieve per-app data counts from the UID bucket table. A reset flag in the call indicates whether, upon transfer, the bucket table values should be reset. The GetPolicyBuckets call allows the CCC daemon to retrieve the current policy bucket values. Finally, the SetPolicyBucketCall allows the CCC daemon to make an adjustment (up or down) to the value of a specific policy bucket.

Two functions are shown in the event callback API 2540. These functions are used by the GFCCC kernel module to alert the CCC daemon of two event types. The DepletionEventCallback is used to alert the CCC daemon that a specific policy bucket has reached its depletion limit, as described above. The FlowClassifyCallback is used to alert the CCC daemon that a flow has been observed for which the GFCCC has no policy.

FIG. 26 contains a block diagram for one embodiment of CCC daemon 2026. Daemon 2026 comprises a NAM service interface 2610, a classification filter matrix manager 2620, a filter matrix store 2622, a kernel policy manager 2624, a kernel policy mirror storage 2626, a state handler 2630, a device and network state store 2632, a kernel context manager 2634, a kernel contexts mirror storage 2636, a reporting/notification module 2640, a usage reconciliation module 2642, a kernel bucket manager 2644, and a kernel buckets mirror storage 2646.

NAM service interface provides an interface to NAM service 2032, and parses traffic to and from service 2032 as to whether that traffic pertains to classification filter matrix manager 2620 (for policies), state handler 2630 (for network and device state and changes), or reporting/notification module (for events and service measures or measure requests).

Classification filter matrix manager 2620 maintains a local copy of the current filter matrix 2622, as calculated by the NAM service. When the filter matrix changes, classification filter matrix manager 2620 alerts kernel policy manager 2624 to review whether changes to the current kernel policies are required. Kernel policy manager 2624 can then change the current kernel policies to match the updated matrix.

State handler 2630 receives notifications of network and device state changes that are relevant to the active policy filter set. When such notifications are received, state handler 2630 makes the changes in the device and network state store 2632, and alerts the kernel context manager. Kernel context manager 2634 can then change the current kernel context if necessary to reflect the updated network and device state.

Reporting/notification module 2640 can receive requests from the NAM service for current usage statistics. When such a request is received, a request is made to the kernel bucket manager to synchronize itself with current kernel bucket values, which are then combined with longer-term statistics held in usage reconciliation store 2642. Service measures can also be supplied to the NAM service on a schedule, e.g., at periodic intervals, after a given number of KB or MB have been consumed, etc. The notification module 2640 is also responsible for notifying the NAM service when a depletion event in a kernel policy bucket triggers a higher-level notification action in the filter matrix.

Kernel managers 2624, 2634, and 2644 work together to translate and effect policies between the more abstract network activity management policy-specific world and the low-level flow policy space present in the kernel. The managers maintain translation tables that allow them to respond to the generic flow events generated by the kernel module with reference to the more abstract data stored in the filter matrix 2622, device and network state 2632, and usage reconciliation 2642.

In some embodiments, the functions of the CCC daemon could be combined with the NAM service, if the combination can respond fast enough to flow classification and bucket replenishment requests. The described arrangement has a potential advantage, however, in that functionality is roughly divided based on the frequency of service required—the GFCCC module needs to work, particularly for established flows, without adding considerable latency to packet traffic; the CCC daemon updates policies in the GFCCC module at a slower rate, based on slower device state changes, and generally will only affect packet latency when a subset of packet flows are established; and the NAM service records and reports the slower state changes and responds to user selections or service controller plan updates.

The NAM service and CCC daemon can be tailored in many different Device-Assisted Services (DAS) configurations, all capable of using the described generic flow classification, control, and counting API as disclosed herein. In some embodiments, DAS for protecting network capacity includes implementing a service plan for differential charging based on network service usage activities (e.g., including network capacity controlled services). In some embodiments, the service plan includes differential charging for network capacity controlled services. In some embodiments, the service plan includes a cap network service usage for network capacity controlled services. In some embodiments, the service plan includes a notification when the cap is exceeded. In some embodiments, the service plan includes overage charges when the cap is exceeded. In some embodiments, the service plan includes modifying charging based on user input (e.g., user override selection as described herein, in which for example, overage charges are different for network capacity controlled services and/or based on priority levels and/or based on the current access network). In some embodiments, the service plan includes time based criteria restrictions for network capacity controlled services (e.g., time of day restrictions with or without override options). In some embodiments, the service plan includes network busy state based criteria restrictions for network capacity controlled services (e.g., with or without override options). In some embodiments, the service plan provides for network service activity controls to be overridden (e.g., one time, time window, usage amount, or permanent) (e.g., differentially charge for override, differentially cap for override, override with action based UI notification option, and/or override with UI setting). In some embodiments, the service plan includes family plan or multi-user plan (e.g., different network capacity controlled service settings for different users). In some embodiments, the service plan includes multi-device plan (e.g., different network capacity controlled service settings for different devices, such as smart phone v. laptop v. net book v. eBook). In some embodiments, the service plan includes free network capacity controlled service usage for certain times of day, network busy state(s), and/or other criteria/measures. In some embodiments, the service plan includes network dependent charging for network capacity controlled services. In some embodiments, the service plan includes network preference/prioritization for network capacity controlled services. In some embodiments, the service plan includes arbitration billing to bill a carrier partner or sponsored service partner for the access provided to a destination, application, or other network capacity controlled service. In some embodiments, the service plan includes arbitration billing to bill an application developer for the access provided to a destination, application or other network capacity controlled service.

In some application scenarios, excess network capacity demand can be caused by modem power state changes on the device. For example, when an application or OS function attempts to connect to the network for any reason when the modem is in a power save state wherein the modem is not connected to the network, it can cause the modem to change power save state, reconnect to the network, and then initiate the application network connection. In some cases, this can also cause the network to re-initiate a modem connection session (e.g., PPP session) which in addition to the network capacity consumed by the basic modem connection also consumes network resources for establishing the PPP session. Accordingly, in some embodiments, network service usage activity control policies are implemented that limit or control the ability of applications, OS functions, and/or other network service usage activities (e.g., network capacity controlled services) from changing the modem power control state or network connection state. In some embodiments, a service usage activity is prevented or limited from awakening the modem, changing the power state of the modem, or causing the modem to connect to the network until a given time window is reached. In some embodiments, the frequency a service usage activity is allowed to awakening the modem, changing the power state of the modem, or causing the modem is limited. In some embodiments, a network service usage activity is prevented from awakening the modem, changing the power state of the modem, or causing the modem until a time delay has passed. In some embodiments, a network service usage activity is prevented from awakening the modem, changing the power state of the modem, or causing the modem until multiple network service usage activities require such changes in modem state, or until network service usage activity is aggregated to increase network capacity and/or network resource utilization efficiency. In some embodiments, limiting the ability of a network service usage activity to change the power state of a modem includes not allowing the activity to power the modem off, place the modem in sleep mode, or disconnect the modem from the network. In some embodiments, these limitations on network service usage activity to awaken the modem, change the power state of the modem, or cause the modem to connect to a network are set by a central network function (e.g., a service controller or other network element/function) policy communication to the modem. In some embodiments, these power control state policies are updated by the central network function.

The various network service plans referenced above are, in at least one embodiment, specified in an integrated network-service design environment that enables centralized, unified, coordinated development of access-control, service-accounting and service-notification policies, and automated translation of developed service policies into provisioning instructions for a diverse variety of network elements and/or end-user devices. Classification objects and policy events are defined and/or organized in multiple hierarchical levels ranging from base-level classification objects to complete catalogs of service plans. This hierarchical organization allows for the ascendant inheritance of object properties through the hierarchy (i.e., elements at higher levels of the hierarchy can inherit or take on one or more properties of elements at lower levels of the hierarchy) and normalizes the collection of design elements at each hierarchical level, enabling, for example, a single design element to be included in multiple design elements at higher hierarchical levels, thus streamlining service plan development and simplifying revision and testing. The integrated design environment contemplates concurrent activation and implementation of “overlapping” service plans for a single end-user device. For example, an end-user device may be associated with or subscribed to more than one active service plan at a time, and, in such cases, more than one active service plan may allow for a particular device activity (e.g., access to a particular web site could be allowed by a service plan providing for unrestricted Internet access, and it could also be allowed by a second service plan that provides for access to the particular web site or a particular application that accesses that web site). The integrated design environment enables plan designers to define control and/or accounting priorities of those plans relative to each other or even to delegate prioritization choices to subscribers or end-users (i.e., service consumers or parties associated with a service account, such as parents, device group managers (e.g., virtual service providers, mobile network operators (MNOs), mobile virtual network operators (MVNOs), etc.), enterprise information technology (IT) managers, administrators, etc.). The integrated design environment may also permit definition of “multi-match” classification and the triggering of multiple policy events per match to effect a richer set of end-user device features and performance than is possible with more conventional classification schemes. The integrated design environment enables designers to define and control end-user discovery of available services, for example, through organization and featuring of plans and promotions on end-user devices, and definition of offers to be presented in response to detecting an attempted access for which a compatible plan is lacking. The integrated design environment may also facilitate definition and management of a broad variety of subscriber groups (and/or sets of end-user devices), and also permit “sandboxed” delegation of precisely defined subsets of service design and/or management responsibilities with respect to specified groups of subscribers or end-user devices.

FIG. 27 illustrates an exemplary device-assisted network in which service plans applicable to an end-user device may be designed using, and provisioned using instructions generated by, an integrated service design center 2701. The view presented is split conceptually between physical and functional interconnections of an end-user device and network operation elements. In the physical view, a mobile end-user device 2703 and network operation elements 2705 are interconnected via one or more networks (e.g., an access network and one or more core networks, shown collectively at 2707, and which may include the Internet) to enable delivery of and accounting for usage of various network services according to one or more service plans designed using, and provisioned using instructions generated by, service design center 2701. Functionally, a service processor 2709, implemented in hardware, software, or a combination of hardware and software, within the end-user device, and a service controller 2711, implemented in hardware, software, or a combination of hardware and software, within one or more of the network operation elements 2714, communicate over a device service link 2712 to enable and account for service usage (e.g., voice, data, messaging, etc.), and to enable on-demand purchasing of various service plan offerings via a user-interface (UI) of the end-user device itself. In the user-interface examples shown at 2715 and 2717, for instance, the end-user device presents various voice, messaging, data and specialized application plans on user-selectable tabs, in each tab prompting the device user to choose from a list of available plans. Service processor 2709 communicates the selection of a service plan and, in some embodiments, information about ongoing service usage within a selected plan, to service controller 2711, which coordinates with other network operation elements and/or elements within the access/core networks to configure the selected service plan and provide the requested service. In some embodiments, the service controller obtains service usage information from the service processor and/or one or more network elements (e.g., base station, radio access network (RAN) gateway, transport gateway, mobile wireless center, home location register, AAA server, data store, etc.) and communicates service usage information to billing infrastructure elements as necessary to account for service usage.

In FIG. 27, service design center 2701 provides an integrated, hierarchical environment that enables a service designer (e.g., a human operator) to perform a wide variety of tasks, including, for example:
design in detail some or all of the voice, data, messaging and specialized service plans offered on or available to a specified collection of end-user devices, where the specialized service plans can be used to define a wide variety of service plans, possibly time-limited, using any conceivable classification, such as a plan that offers voice and/or messaging service up to a specified usage limit (e.g., specified minutes of voice and/or number of texts), or a plan that offers access through a particular end-user device application (“app”) (e.g., a plan that allows unlimited use of the Facebook app for a day), or a plan that offers access to a particular network destination (e.g., access to a particular web site for a specified period of time, etc.), or a plan that offers access to a particular type of content (e.g., streaming content, video content, audio content, etc.), or a plan that offers access to a particular category of services (e.g., access to social networking services through specified apps and web sites);
translate an output of the hierarchical design environment into network element and/or end-user device provisioning instructions necessary to provide and account for plan services under the available service plans;
manage end-user discovery of available services, applications, content, transactions and so forth, including managing the organization, display and promotion of available plans on end-user devices and managing presentation and acceptance of plan offers in response to detecting an attempted access for which no compatible plan has been purchased, or for which a less expensive or otherwise more user-appealing plan is available;
design accounting rules and configure information associated with accounting entities (e.g., AAA servers, online charging systems, offline charging systems, mediation platforms, home location registers, messaging gateways, etc.) (including third-party service sponsors) for end-user service plans and plan components;
design access rules and configure information associated with access control entities (including network elements (e.g., DPI systems, access gateways, AAA servers, online charging servers, messaging gateways, etc.))
manage subsets of subscribers and/or end-user devices (e.g., associated with an enterprise, device group, mobile virtual network operator, virtual service provider, carrier, etc.) with a pre-defined set of permissions according to designer credential established at login (i.e., as shown at 2720 within the exemplary service design center introduction display 2719); and/or
analyze profitability, usage, user-satisfaction metrics, etc. to assist in fine-tuning and/or upgrading or modifying offered service plans.

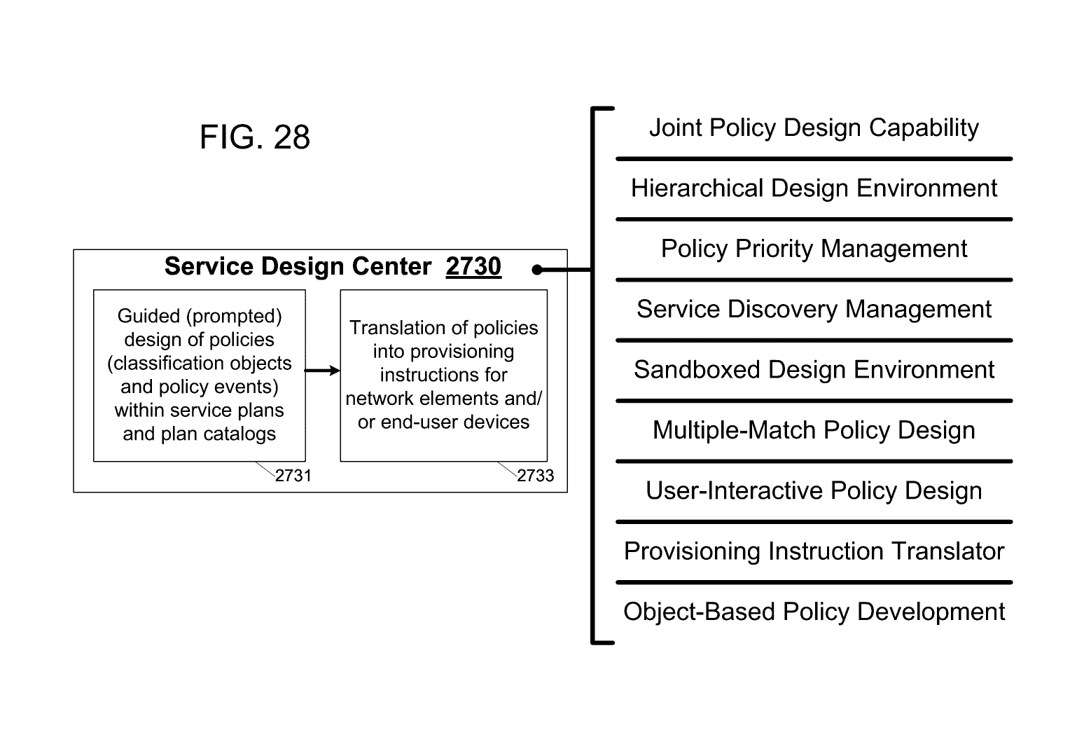

FIG. 28 illustrates the integrated service design center 2730 conceptually, depicting high-level service design and provisioning operations together with a non-exhaustive list of design center capabilities and features. As shown, service design center 2730 guides (or prompts) a service designer through the design of service polices within service plans and/or catalogs of service plans (2731) and then translates the service policies defined for the designed service plans into provisioning instructions for network elements and/or end-user devices (2733). In contrast to prior approaches in which at least access-control and accounting policies are disaggregated and separately designed, integrated service design center 2730 enables those policies and complementary notification policies to be jointly designed in a centralized, hierarchical design environment. Further, integrated service design center 2730 provides a rich set of design tools that permit plan designers to set priorities for when service plans and/or plan components overlap (i.e., when a particular device activity is within or is covered by more than one service plan or plan component), manage and promote end-user discovery of available services or service plans, and define multiple-match classification sequences (e.g., what to do when a particular device activity fits within more than one classification) and user-interactive policy application (e.g., dynamically determining and/or modifying the policy to be applied in response to a filter-matching event based on user-input), all together with a provisioning instruction translator that generates, according to the service design output, the various provisioning instructions required to provide and account for planned services, and for various network elements (e.g., network equipment, the end-user device, etc.) to implement the policies applicable to such services. Moreover, the service design center supports object-based service policy development, enabling a service designer to carry out service plan design through creation, organization, testing, revision and deployment of reusable policy objects at every hierarchical level of the plan design.

### Joint Policy Design

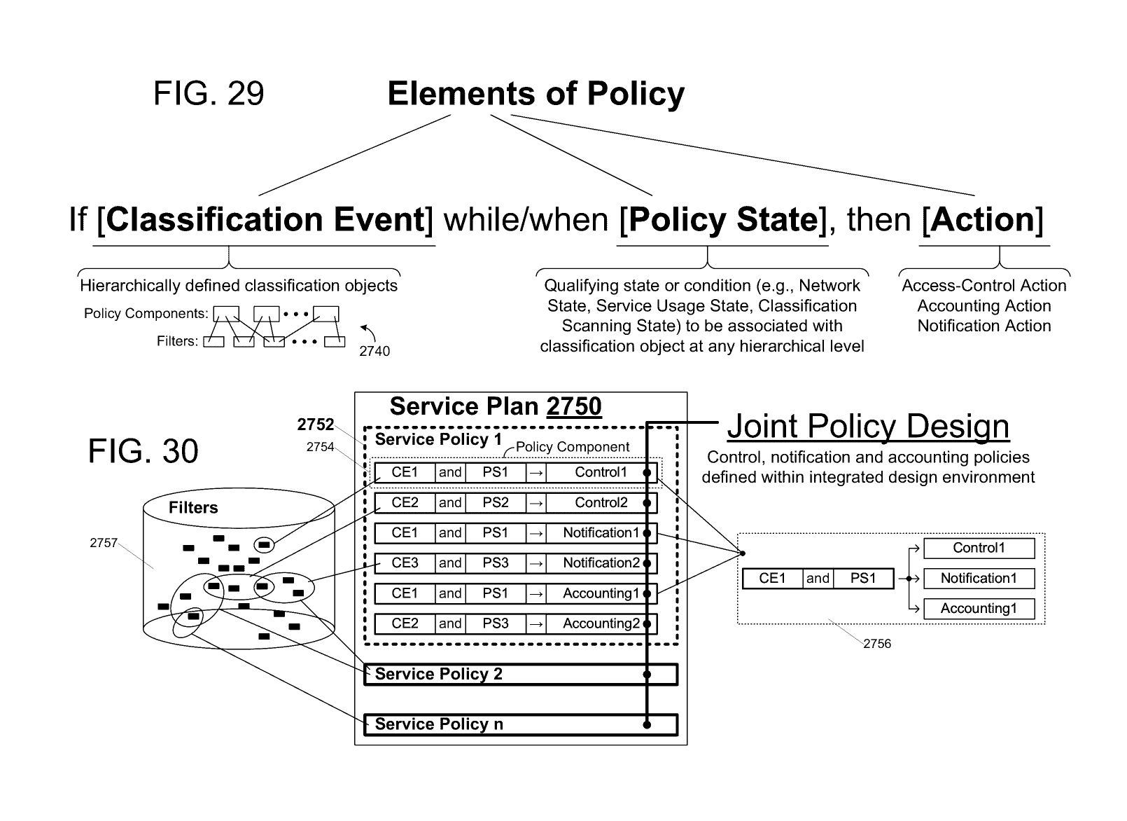

FIG. 29 illustrates exemplary policy elements that may be defined using and provisioned by the integrated service design center of FIG. 28. As shown, a policy may be defined as one or more actions carried out in response to (i.e., triggered by) detecting a classification event while or when in a policy state, with the action, classification event, and policy state may each be specified by a plan designer through interaction with the integrated service design center. In general, classification events are matches between designer specified classification objects and attempted or actual service access events. In a number of embodiments described below, service activity filters (or “filters”) constitute base-level classification objects, with one or more filters forming constituents of a higher-level object referred to herein as a service policy component (or “component”). This hierarchical definition of classification objects, illustrated graphically at 2740 in FIG. 29, provides a number of benefits, including object normalization (i.e., a single filter definition may be incorporated within multiple components, rather than requiring redundant filter definitions within respective components), property inheritance (properties defined with respect to filters are imputed to incorporating components) and hierarchical development (i.e., respective service designers or groups of designers may be tasked with lower-level filter design and higher-level component design) to name a few. The integrated service design center thus allows personnel with differing skills and knowledge to participate in service plan design/configuration. For example, an engineer could use the integrated service design center to design filters and/or components for use in service plans without having any knowledge of the service plans that subscribers are likely to want. For instance, the engineer could design a filter to identify network access attempts associated with the Facebook app on an end-user device without knowing how that filter might be incorporated into a service plan or how that filter might be used to define a new service. Conversely, a marketing individual with knowledge of network services subscribers are likely to want, but lacking know-how to implement underlying filters and or other more technical design objects, may nonetheless design marketable services or service plans by leveraging the filters and/or components designed by the engineer. For example, the marketing individual could design a “Facebook app for a day” service using the Facebook app filter designed by the engineer. The integrated service design center thus facilitates collaborative definition and deployment of service plans and services by allowing service design activities to be partitioned at different levels of the design hierarchy and engaged by individuals most knowledgeable or otherwise best suited for the design activity at hand.

Still referring to FIG. 29, policy state refers to a temporal condition such as a network state, classification-scanning state, service usage state and/or transition with respect to network, classification-scanning or service-usage states that, if in effect at the time of the classification event, will trigger the policy action, which, as shown, may be either an access-control action, an accounting action, or a notification action. Thus, the policy state may be viewed, from a Boolean perspective, as a qualifier to be logically ANDed with the classification event (i.e., match detection with respect to classification object) to trigger the policy action. As explained below, the policy state associated with a given classification object may be set to an “always true” state (e.g., “any network state” and “any service usage state”) so that any match with respect to the classification object will trigger execution of the corresponding policy action. For example, if a sponsored text messaging service is available (e.g., a service sponsor has decided to offer some number of free text messages to a particular group of end-user devices), it might be desirable to provide a notification to every end-user device in the group of the availability of the sponsored text messaging service, regardless of whether those end-user devices are already able to send or receive text messages. Conversely, the classification event defined by a classification object may be set to an “always TRUE” condition (i.e., no access event or attempted-access event required) so that any match with respect to the policy state definition will trigger execution of the corresponding policy action. Examples include actions triggered in response to entering or leaving a roaming network, detecting availability of a known WiFi network for offloading, etc. In a number of examples described below, policy states and corresponding policy actions are defined conjunctively by a service designer as “policy events”—actions to be performed if an associated classification object is matched while/when one or more policy states are true.

FIG. 30 illustrates an exemplary joint policy design—a combination of access-control, notification, and accounting policies or any two of those three policy types—that may be defined and provisioned using the integrated service design center of FIG. 28. To be clear, while FIG. 30 illustrates all three of access-control, notification, and accounting policies, it should be understood that joint policy design may involve only two types of policies, such as access-control and notification, or access-control and accounting, or notification and accounting. Proceeding hierarchically from top to bottom (and graphically from outside in), a service plan 2750 is defined to include one or more service policies 2752, with each service policy including one or more service policy components 2754 and each service policy component constituted by the policy elements described in reference to FIG. 29 (i.e., a classification event (CE), policy state (PS), and triggered action). For example, the top row specifies classification event “CE1,” policy state “PS1,” and triggered action “Control1”; the second row specifies classification event “CE2,” policy state “PS2,” and triggered action “Control2”; and so forth. The classification event within each service policy component results from a match with a component-level classification object constituted by one or more filters within, for example, a database of filter definitions 2757. In the example shown, and in a number of examples discussed below, policy events (i.e., combined policy state and policy action definitions) are defined at the policy component level, but such definitions may generally be applied at any hierarchical level within the plan design.

As a matter of terminology, individual policy components are distinguished herein as access-control policies (or “control policies” for short), accounting policies, and notification policies according to the nature of their triggered actions. For example, the six exemplary policy components 2754 within the first service policy instance (i.e., “Service Policy 1”) include two control policy components (indicated by policy actions “Control1” and “Control2”), two notification policy components, and two accounting policy components (of course, the inclusion of the six exemplary policy components 2754 within the first service policy instance is merely illustrative—more or fewer components may be included within a given service policy). Likewise, it is not necessary that the components include all three of control, notification, and accounting, or that the number of each type be equal. As described above and in further detail below, the hierarchical definition of filters and component-level classification objects enables filters within database 2757 to be re-used within a given service policy 2752, as in the definition of classification events CE2 and CE3, and also within different service policies. Also, the same classification event may be associated with two or more policy events within respective policy components as in the policy components that yield control, notification, and accounting actions (Control1, Notification1, Accounting1) in response to classification event CE1 during policy state PS1. Further, while each policy component is shown as triggering a single control action, a single policy component may be defined to include multiple actions in an alternative implementation or configuration. Thus, instead of requiring three separate policy component instantiations to effect the Control1, Notification1, and Accounting1 actions, a single policy component may be defined to trigger those three actions (or any combination of actions, including two or more actions of the same type) as shown at 2756. In addition to enabling efficient, joint policy definition within an integrated design environment, this design flexibility permits the design of arbitrarily complex policy implementations, including policies that support multiple-match classification sequences and “interceptor” policies that detect attempted access to an unsubscribed service and interact with a user to offer and activate one or more access-compatible service plans.

The consistent joint (integrated) policy definition and enforcement framework enabled by the systems considered herein is tremendously advantageous in the design and provisioning of enhanced policy enforcement capability, lower complexity and reduced network cost, reduced latency in user service notifications, and real time interaction between service plan policy options and user preferences to enhance the user experience and increase the opportunities to effectively market and sell new types of services and service plans or bundles. As described above, joint policy definition and enforcement framework refers to the capability to define and deploy filters (or collections of filters) conditioned on policy state and associate the conditioned filters with any of three policy types: control, accounting and notification. For example, a service activity (e.g., access or attempted access) that yields a match with respect to a filter (or collection of filters) defined as a “data communication type” and conditioned on “service limit reached” (a policy state) can be associated with a joint policy actions comprising “cap” (a control action triggered by the policy-state-conditioned filter match and thus a control policy) and “send plan modification required notification ” (a notification action triggered by the filter match and thus a notification policy). This “cap and notify” joint policy construct allows for simultaneous execution of real-time capping (when the service limit is reached) and real-time user notification that the limit has been reached. Because the notification action is triggered at the same instant as the cap was enforced (i.e., both actions are triggered by the same policy-state-conditioned filter matching event), and the notification trigger can cause the notification system to deliver a user interface message to be displayed on the device UI in fractions of a second to a few seconds, the device user experiences a notification explaining why the service has been stopped precisely when the user has requested service and thus while the user's attention is directed to execution of the requested service (i.e., coincident in time with the service being stopped). Further, the UI message may include or be accompanied by information of various options for resolving the service stoppage, including on-the-spot offers to activate one or more service plans that will enable the requested service. Thus, in contrast to a disaggregated policy design/implementation in which notice of plan-expiration may arrive minutes or hours after the relevant service request with no option for resolution beyond calling a “customer care” call center (i.e., an untimely notification of a problem with no clear or immediate avenue for correction—in essence, a nuisance), a joint or integrated policy as presented herein enables instantaneous notification of the plan exhaustion event together one or more options for immediate resolution and allowance of the requested service access, apprising the network-service consumer of a problem and offering one or more solutions (including offers to purchase/activate additional service plans) precisely when the consumer is most likely to make a purchase decision. From a system design perspective, by providing the capability to associate a filter match definition with multiple policy types (i.e., as in the above example of joint (or integrated) policy design) there is no longer a need to have separate communication service control and communication service notification systems because both functions are accomplished with the same system.

As another joint or integrated policy example, a filter match comprising “data communication type” (a filter or component) conditioned on “service limit reached” (a policy state) can be associated with a joint policy comprising “stop accounting to base service plan bucket” (a first accounting policy), “begin accounting to service overage bucket” (a second accounting policy), and “send service overage now in effect notification” (a notification trigger policy). As in the preceding cap and notify example, this exemplary “cap and match” joint policy provides real-time notification to make the end-user immediately aware of service plan status (i.e., capped in this example), thus allowing the end-user to potentially modify his/her service plan or usage behavior. As the cap and match example also demonstrates, the single, simplified joint policy enforcement system obviates the separate accounting and notification systems that plague conventional approaches.

As another joint policy example, three-way joint policy enforcement may be achieved through definition of a filter comprising “data communication type” (a “data” filter or collection of data filters) whose match is conditioned on a “service limit reached” policy state and triggers, as control, accounting and notification actions, a “restrict access to service activation destinations” (a control action, and thus a control policy), a “stop accounting to base service plan bucket” (an accounting action and accounting policy), and a “send new service plan or service plan upgrade required” notification (a notification action and therefore a notification policy). In this example the complexity of having separate accounting, control and notification systems that are difficult to program and provide poor notification response times is avoided and replaced with an elegant, simple, less expensive and easier to program joint policy system that provides real time user notification.

As mentioned briefly above, embodiments of the integrated service design center also enable design and deployment of interactive (or dynamic) service policies. Continuing with the data filter example presented above, a match with respect to a data filter conditioned (or qualified) by a “service limit reached” policy state can be associated with a joint user-interactive policy comprising “cap until user response received” (a user-interactive control policy), “stop accounting to base service plan bucket” (an accounting policy), and “send the service plan offer corresponding to the data limit reached condition” (a user-interactive notification trigger policy). Thus, the SDC embodiments described herein provide not only for enhanced policy enforcement capability, lower complexity and reduced latency for a better user experience, but also real-time interaction between service plan policy options and user preferences, further enhancing the user experience and increase the opportunities to effectively market and sell new types of services and service plans or bundles.

As another example illustrating a joint policy design, a first data filter match conditioned by a “95% of service limit reached” policy state can trigger (or otherwise be associated with) a “send service limit about to be reached” notification (i.e., a notification policy), and a second data filter match conditioned by a “100% of service limit reached” can trigger a “cap” control action (i.e., a control policy). Thus, in this joint policy design example, the integrated service design center enables definition of a common (or shared) data-communication-type filter that is conditioned on two different policy states and, when matched in conjunction with the respective policy states, triggers distinct notification and control actions.

As another example illustrating a joint policy design, a first filter match comprising “Amazon” (a filter or a component) conditioned on “sponsored Amazon limit not reached” (a policy state) can be associated with “allow” (control policy) and “account to sponsored Amazon bucket” (an accounting policy), and a second filter match comprising “Amazon” (a filter or a component) conditioned on “sponsored Amazon limit reached” (a policy state) can be associated with “stop accounting to sponsored Amazon bucket” (an accounting policy), “send acknowledgement for ‘Free Amazon service limit reached for this month, would you like to continue with Amazon charged to your data plan?’ notification” (a user-interactive notification policy) and “cap until user response received” (a user-interactive control policy), “if user agrees, cap-match” [e.g. continue searching for a match] (a user-interactive policy to proceed down the Z-order to find another match), and “if user does not agree, cap-no match” (a user-interactive control policy). This is an example of a multi-match policy set where Amazon is first tested for the sponsored service filter until the sponsored service use bucket limit is reached, then a cap-match command is executed and, if there is another Amazon filter match before the “no capable plan” end filter is reached (e.g. a user data plan bucket that is not over its limit), then a second match will be found in the prioritization order.

As another example illustrating a joint policy design, at a first time a first filter match comprising “application update” (a filter or a component) conditioned on “application background status” (a first policy state) and “roaming network condition in effect” (a second policy state) can be associated with “block” (a control policy), and at a second time a second filter match comprising “application update” (a filter or a component) conditioned on “application foreground status” (a first policy state) and “roaming network condition in effect” (a second policy state) can be associated with “allow” (a control policy), and at a third time a filter match comprising “application update” (a filter or a component) conditioned on “application background status” (a first policy state) and “home network condition in effect” (a second policy state) can be associated with “allow”. Thus, in this example a filter is conditioned on two policy state conditions (home/roaming network state and foreground/background application state), wherein in a background application update is allowed unless it is occurring on a roaming network, and a foreground application update is always allowed. This example simultaneously demonstrates two advantageous capabilities that may be achieved through joint policy design: the ability to modify control policy (or accounting or notification policies) as a function of network type and also the ability to modify control policy as a function of foreground versus background application status.

As another example illustrating joint policy design, a filter match comprising “no capable plan” (the final filter in the Z-order search) conditioned on “Vodafone Spain roaming network condition in effect” (a policy state) can be associated with “send the service plan offer corresponding to roaming on Vodafone Spain” (a notification policy), and “cap and wait for response” (a user-interactive control policy). Further, as a pure notification example, a filter match comprising “voice communication type” (a filter or component) conditioned on “80% of service limit reached” (a policy state) can be associated with “send ‘you have 20% left on your talk plan’ voice notification message” (a notification policy).

As a marketing interceptor example, a filter match comprising “no capable data plan” (the final filter in the Z-order search) with no condition can be associated with “send the free try before buy service offer” (a notification policy), and “cap and wait for response” (a user-interactive control policy).

As another marketing interceptor example embodiment, a filter match comprising “Facebook” (a filter or component) can be associated with “notify and continue” (a notification trigger policy) and “send Google+sponsored cellular service offer” (a notification policy). In this example the special command “notify and continue” is provided as an example of the expanded policy enforcement instruction set that can lead to additional policy capabilities—in this case simplified and powerful notification based on user activity with their device. The notify and continue command example provides for a notification trigger that results in a notification being sent to the device UI (in this case an offer for free Google+access on cellular networks) with no impact on service plan control or accounting and without interfering with the service activity to match with a filter in the Z-order search. The “continue” in “notify and continue” refers to the process of allowing the Z-order search process to proceed to find a match under the service plan policies in effect.

As another example of joint policy design and implementation, a notification policy may specify that when an end-user device that is not associated with (subscribed to) a service plan that provides for text messaging attempts to send a text message, a notification is provided through a user interface of the end-user device. In this example, the policy state is that the end-user device is not associated with a service plan that provides for text messaging, the classification event is that the end-user device attempted to send a text message, and the action is to provide a notification through the user interface of the end-user device. As another example, a control policy may specify that when an end-user device that is not associated with (subscribed to) a service plan that provides for text messaging attempts to send a text message, the text message is blocked. In this example, the policy state is that the end-user device is not associated with a service plan that provides for text messaging, the classification event is that the end-user device attempted to send a text message, and the action is to block the attempted text message. The policy may specify more than one action. For example, continuing with the examples above, a policy may specify that when an end-user device that is not associated with (subscribed to) a service plan that provides for text messaging attempts to send a text message, the attempted text message is blocked, and a notification is provided through a user interface of the end-user device. In general, classification events are matches between designer-specified classification objects and attempted or actual service access events. For example, in the text message example provided above, the designer-specified classification object is an attempt to send a text message, and the attempted or actual service access event is that the end-user device attempted to send a text message.

### Hierarchical Design Environment

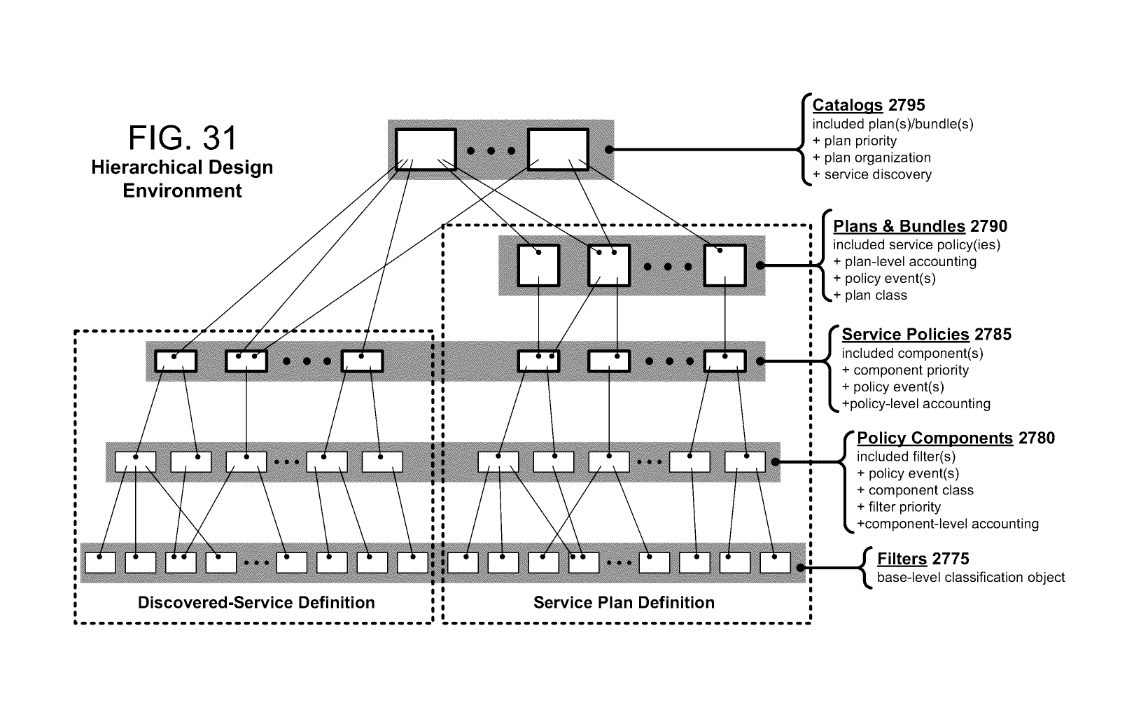

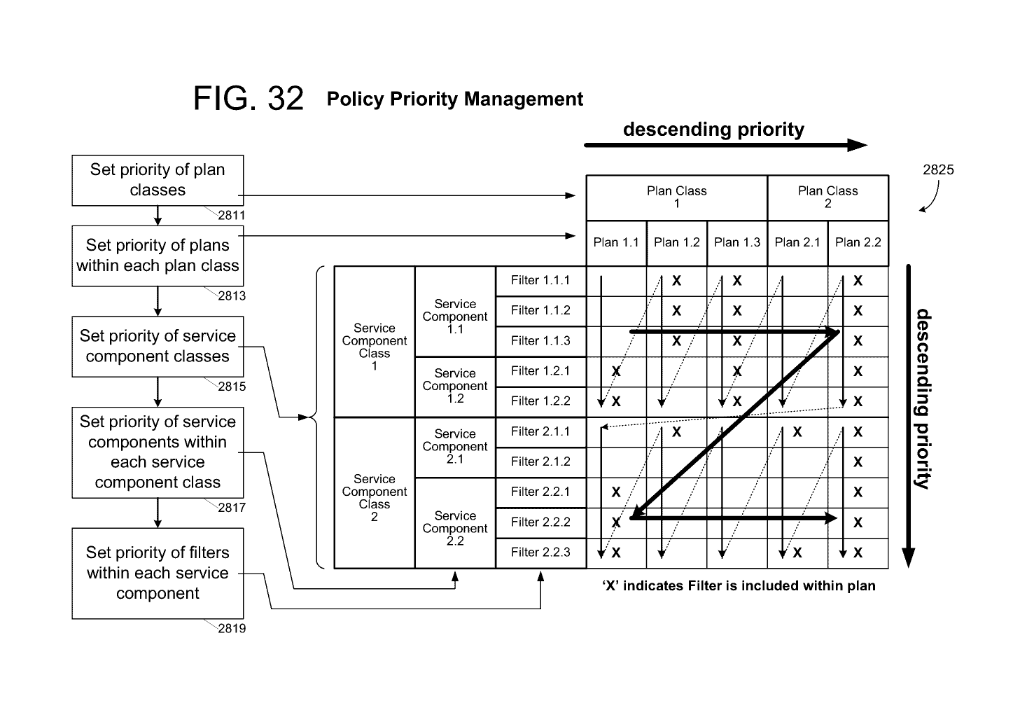

FIG. 31 illustrates a hierarchical service plan structure. Proceeding from bottom up through the hierarchy, filters 2775 form base-level classification objects to be incorporated into service policy components 2780 at the next hierarchical level. As shown, each service policy component includes, in addition to the incorporated filter(s), one or more policy event definitions together with a component service class definition, filter priority specification and optional component-level accounting specification. As discussed in reference to FIG. 29 and in further detail below, each policy event definition specifies a policy state and triggered action (i.e., an access-control, notification or accounting action), thus establishing, in conjunction with the incorporated filter set, the policy elements presented semantically in FIG. 29. As shown in FIG. 31 (and described above), each service policy component 2780 may include filters that are incorporated within other service policy components, enabling a single filter definition to serve as a classification object within multiple service policy components. The component service class definition is applied, in at least one embodiment, to prioritize between potentially conflicting applications of different service policies to a given service activity (e.g., when one service policy specifies to block the service activity, and another service policy specifies to allow the service activity), and the filter priority definition likewise prioritizes the classification sequence between individual filters of a service policy component (e.g., if a service activity fits two classifications, which classification wins). Policy priority management is discussed in greater detail below in reference to FIG. 32.

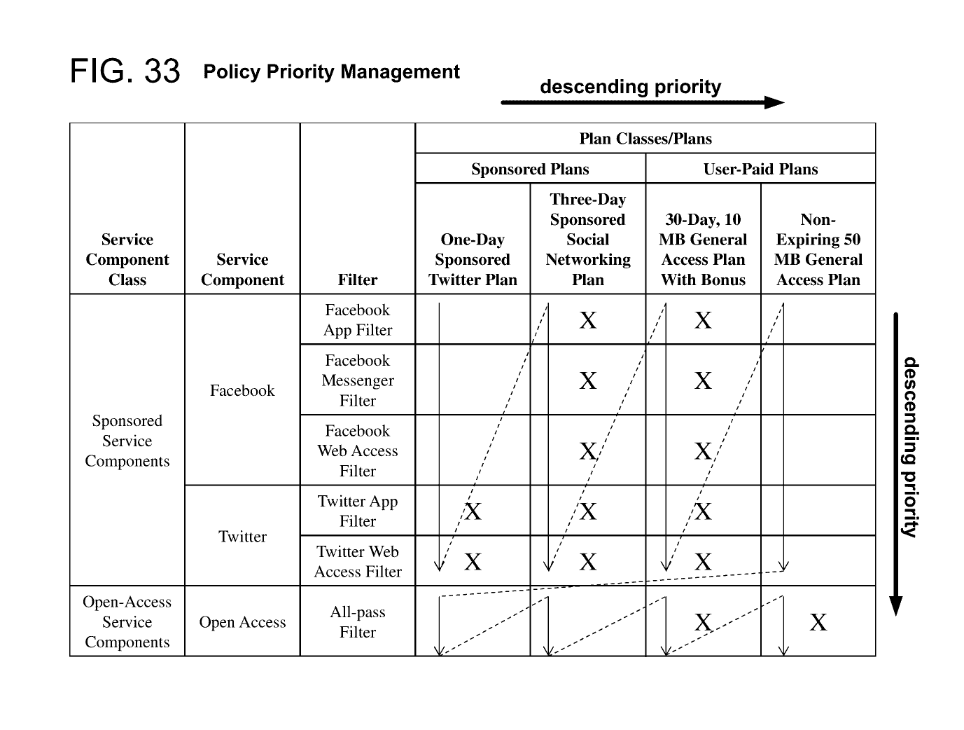

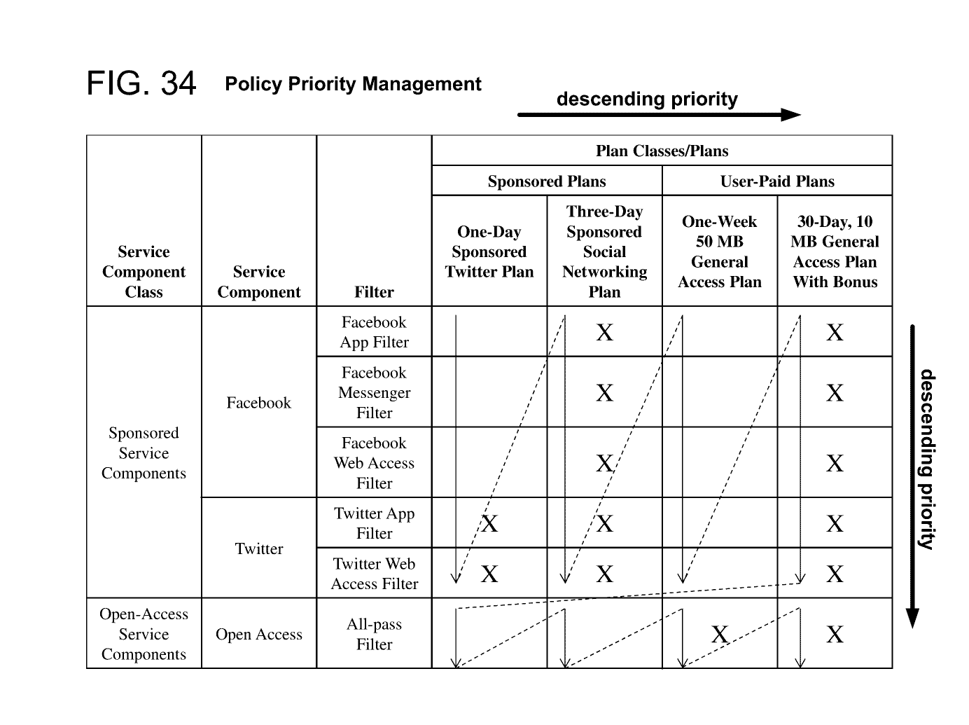

Proceeding to the next hierarchical design level shown in FIG. 31, service policies 2785 are defined by inclusion of one or more service policy components, together with a component priority specification, an optional number of multi-component (or “service-policy-level”) policy event definitions and policy-level accounting specifications. As an example, a service policy underlying a social networking plan may include separate service policy components for different types of social networking services—a Facebook service policy component that enables access to a Facebook app, for instance, and a Twitter service policy component that enables access to a Twitter app. Each of those service policy components may themselves include any number of filters and policy event definitions as explained below. The component priority specification enables prioritization between same-class service policy components, and the multi-component policy event specification permits association of a single policy event with the classification objects within all incorporated service policy components—in effect, defining multiple service policies through a single, shared policy event specification. The examples described below in reference to FIGS. 33 and 34 demonstrate the value and power of intra-class prioritization with regard to plans, for instance, by enabling the service designer to prioritize an earlier-to-expire plan ahead of a later-expiring one. The ability to prioritize between same-class service policy components similarly empowers the service designer (or user, based on a preference setting) to reliably predict/control which service policy component will be applied first to enable a given service activity. For instance, the service designer may prioritize a more generic component beneath a more specific one (e.g., “Social Networking component” prioritized beneath a Facebook component) or prioritize between open access/no-streaming and open access/with-streaming plans.

The hierarchical design levels described thus far (i.e., filters, policy components and service policies) may be applied in either a service plan definition or in discovered-service constructs, such as the marketing interceptors (or “interceptor” policies) mentioned above, which can detect attempted accesses to an unsubscribed service and interact with a user to offer and activate one or more services. FIG. 31 reflects this division between plan definition and discovered-service definition as a separation of constituent design objects at and below the service policy level in the design hierarchy. Note that, though depicted (for convenience) as mutually exclusive within the service plan and discovered-service definitions, the various design objects at each hierarchical level (i.e., filters, policy components and/or service policies) may be shared between service plan and discovered-service definitions. More generally, some types of discovered-service constructs may be viewed as special configurations of service plans. For example, a marketing interceptor may be viewed as a plan with a disallow access-control policy and a notification policy, triggered by a particular policy state (e.g., classification scanning state =Disallow and NO Match is seen, as discussed below), that yields a message prompting the user of an end-user device to activate one or more optional service plans.

Continuing upward to the next hierarchical level within a service plan definition, service plans and service-plan bundles 2790 (the latter being referred to in shorthand herein as “bundles”) are defined by incorporation of one or more service polices together with a specification of optional plan-level accounting policies, plan-level policy events and plan class. In one embodiment, plans and bundles are distinguished by quantity of incorporated service policies with service plans each incorporating a single service policy, and service-plan bundles each incorporating multiple service policies (i.e., establishing, in effect, a bundle of service policies). As discussed below, the multiple service policies within a bundle are generally billed as a collective service, but may be accounted for separately, for example, to enable costs of constituent service policies to be broken out for taxation, analytic or other purposes.

In a number of embodiments, plan-level accounting enables billing on recurring or non-recurring cycles of designer-specified duration, and thus complements any policy-based accounting actions (e.g., component-level, policy-level or plan-level accounting according to service usage in addition to or instead of accounting per temporal cycle). In one embodiment, for example, the service design center permits the specification of a minimum number of billing cycles to transpire (and/or a calendar date or other criteria) before plan cancellation is permitted, and also whether plan usage metrics are to be reset or usage limits varied (e.g., usage rollover) at the conclusion of a given accounting cycle. Other examples include proration rules, sharing rules, etc.

Plan-level policy event definition, like policy event definition at the service policy level, permits a single policy-event definition to be associated with the classification objects incorporated from lower hierarchical levels, thus enabling a conceptually and logistically efficient definition of numerous policies having a shared plan-level policy state and triggered action, but different classification events. Plan class specification enables prioritization between service plans according to, for example, the paying entity, nature of the service, and so forth. In one embodiment, for example, plans may be differentiated as either sponsored (i.e., a third party pays for or otherwise defrays the cost of service in part or whole) or subscriber-paid, with sponsored plans being prioritized ahead of subscriber-paid plans. By this arrangement, sponsored and subscriber-paid plans for otherwise identical services may coexist, with the plan prioritization ensuring usage of a sponsored plan before its subscriber-paid counterpart (or vice-versa). As another example, plans that enable service activation may be differentiated, as a class, from service-usage plans, with activation-class plans being prioritized ahead of their service-usage counterparts. Such prioritization can be used to ensure that a user service plan is not charged for data access required to activate a service plan (or for service plan management).

In the embodiment of FIG. 31, the top hierarchical design level is occupied by plan catalogs (or “catalogs”) 2795, each of which constitutes a complete collection of service plans and bundles to be published to a given end-user device group (i.e., one or more end-user devices) or subscriber group (i.e., one or more subscribers). Accordingly, each plan catalog is defined to include one more service plans and/or service-plan bundles instantiated in the hierarchical level below, together with an indication of relative priority between same-class plans and, optionally, a one or more plan organization specifications (e.g., add-on plans, base plans, default plans such as carrier plans and/or sponsored plans, etc.). As shown, each plan catalog also may also include one or more discovered-service objects (e.g., marketing interceptors expressed by service policy definitions within the discovered-service branch of the design hierarchy) and may define various service-discovery functions such as promotions or “upsells” of available plans or bundles (e.g., presented in banner ads, scheduled pop-ups, usage-driven notifications, etc.), organization and featuring of cataloged plans within the user-interface of an end-user device, and so forth. Thus, altogether, the plan catalog design, together with properties and features inherited from lower-level design objects, defines an overall experience intended for the user of an end-user device, from service offering to service execution, with complete expression of all applicable access-control, notification and accounting policies, merged with point-of-need promotion of available services, all according to design within the integrated service design center.

Still referring to the design hierarchy of FIG. 31, the following examples illustrate the manner in which plan-level accounting, policy-level accounting and component-level accounting may be applied in different service designs:
1—Component level accounting for Amazon access is sponsored by Amazon or carrier. Accordingly, a service designer may define all the filters that comprise Amazon access and create a component with these filters, defining an accounting policy to account to an Amazon charging code for access or attempted access during specified network states (i.e., specified in policy state definitions, which may include policy states in addition to or other than network states) such as, for example, access via home cellular network and WiFi network. The service designer may further assign accounting policy to not account to Amazon charging code and instead charge a user-paid plan for other network states (e.g., access via roaming network) and assign a high classification priority to the sponsored components to ensure that Amazon is charged for network states Amazon is supposed to be charged for before user plan usage is charged. Accordingly, by including such a service policy component within a user service plan, Amazon will be charged for access via home or WiFi networks before user is charged.
2—Component level accounting for Amazon access is sponsored by Amazon or carrier. A service designer may define all the filters that comprise Amazon access and create a component that includes these filters, assign control policy to allow and accounting policy to account to an Amazon charging code for some network states such as, for example, home cellular network and WiFi network. The service designer may then assign a control policy to disallow Amazon access for other network states (e.g., roaming network) and assign a high classification priority to make sure Amazon is charged for network states Amazon is supposed to be charged for before user plan usage is charged, place this component within a user service plan so that Amazon is charged before user bucket is charged for home or WiFi network states, by not allowing the component when roaming the multi-match Z-order filter match process will not show a match when roaming and the Z-order process will then search for another match such as a user paid roaming plan.
3—Component level accounting for Amazon access is sponsored by Amazon or carrier, define all the filters that comprise Amazon access and create a component with these filters, assign control policy to allow and accounting policy to account to Amazon charging code for some network states such as for example home cellular network and WiFi network, assign control policy to “not allow” Amazon and to “notify and require acknowledgement” of roaming charges for Amazon for other network states such as roaming network, if user does not acknowledge charge then block Amazon and don't seek another filter match, if user does acknowledge charge then allow Amazon access to seek another match in the Z-order process, assign a high Z-order priority to make sure Amazon is charged for network states Amazon is supposed to be charged for before user plan usage is charged, place this component within a user service plan so that Amazon is charged before user bucket is charged for home or WiFi network states, by not allowing the component when roaming the multi-match Z-order filter match process will not show a match when roaming and the Z-order process will then search for another match such as a user paid roaming plan.
4—Roaming component is provided in service plan, define roaming filters into a component for all networks that are allowed in roaming plan, assign roaming accounting policy and control policy, place high in Z-order so that roaming is charged at a special rate before home user bucket is charged.

The foregoing instances of plan-level, policy-level and component-level accounting are provided for purposes of example only and to make clear that accounting actions may be specified at any level of the service design hierarchy where beneficial to do so, including at multiple hierarchical levels. Prioritization (and/or conflict resolution) between accounting actions defined at two or more hierarchical levels may be controlled by explicit or implied input from the SDC user (i.e., with such input forming part of the overall service design specification) and/or established by design or programmed configuration (e.g., as in a user preference setting) of the SDC itself.

### Policy Priority Management

FIG. 32 illustrates an exemplary approach to managing policy priority within the integrated service design center of FIG. 28 that leverages the design hierarchy of FIG. 31. It should be clear in light of the teachings herein that it is possible, using the service design center, to design and make available to end-user devices a wide variety of services and service plans. As a simple example, a designer could use the service design center to create not only “open-access” plans that allow unrestricted access, but also specialized service plans that enable access to social networking services. Assume that the designer creates three service plans: (1) an open-access plan that allows 50 MB of unrestricted Internet access, (2) a service plan that allows access only to Twitter, and (3) a social networking plan that allows access to both Facebook and Twitter. If an end-user device is subscribed to all three of these plans, and the device accesses Facebook, the service usage could be accounted either to the open-access plan or to the social networking plan. If the end-user device accesses Twitter, the service usage could be accounted to any one of the three plans. There is thus a need for rules or a methodology to establish the order in which the applicable service policies (e.g., one or more of accounting, control, and notification) are applied.

If a user or subscriber has paid for all service plans enabling the end-user device to access services, and none of the plans expires, then the order in which the plans are used up (i.e., the order in which service usage is accounted to the service plans) does not matter. But if a service plan is, for example, provided at no charge to a user or subscriber, and a particular service usage fits within that no-charge plan, then it may be desirable to account for the particular service usage within the no-charge plan instead of accounting for the service usage to a user-paid plan. Likewise, if a first service plan (whether user-paid or provided at no charge to the user) is nearing expiration (e.g., will cease to be available in three hours), and a second service plan under which a particular service usage could be accounted does not expire, it may be desirable to account for the particular service usage within the first service plan, if possible. By knowing variables such as whether a service plan is partially or entirely user-paid (or, conversely, whether a service plan is partially or entirely sponsored), whether a service plan expires, etc., a service designer can use the service design center to control whether, and in what order, service policies (e.g., accounting, control, and notification) are applied when an end-user device engages in various service activities (i.e., use of apps, access to Internet destinations, transactions, etc.). A policy enforcement engine (e.g., implemented by one or more agents within a network element and/or end-user device) may also apply the priority information to dynamically alter the priority order, for example, in view of fluctuating priority relationships that may result from the timing of plan purchases and/or automatically cycling (i.e., auto-renewing) plans. Also, while not specifically shown in FIG. 32, otherwise equivalent (or similar) plans may be prioritized based, for example, on service expiration (e.g., based on time remaining in a time-limited plan and/or usage remaining in a usage-capped plan). Thus, while FIG. 32 illustrates a relatively static priority organization, the relative priority between objects within the design hierarchy (e.g., plans, plan classes, service components, service component classes, and/or filters) may be changed dynamically in accordance with information provided within the service design center.

In the embodiment shown in FIG. 32, the relative priorities between different classes of plans are established at 2811, with the priorities between plans within each class being set at 2813. Examples of plan classes are carrier plans (e.g., plans that provide for carrier services, such as over-the-air updates), sponsored plans (e.g., plans that are subsidized, paid-for, or sponsored in some other manner by a third-party sponsor), and user plans (e.g., plans that are paid-for by the user or a subscriber). Similarly, the relative priorities between different classes of service policy components (also referred to herein as “service components,” “policy components” and “components”) is established at 2815, and the priorities between service policy components within each component class is set at 2817. The relative priorities between filters within a given service policy component may be established at 2819. Note that the use of plan classes is optional and that specific plan class and component class names shown in FIG. 32 and further examples below are provided to assist the human service designer in managing priorities of the plans and components. Additional or alternative plan classes, component classes and names of such constructs may be used in alternative embodiments.

Although a top-down sequence of priority definition is shown in FIG. 32 (i.e., according to design hierarchy), the prioritization at different hierarchical levels may be set in any order, including a bottom up sequence in which filter priority is defined first, followed by service component priority and so forth. Moreover, the priority definition (i.e., assignment or setting of the relative priorities of two or more objects) at a given hierarchical level may be implied or predetermined within the service design center rather than explicitly set by the service designer. In one embodiment, for example, the priority between service component classes is predetermined within the service design center so that a designer's specification of component class for a given service component effects an implicit priority definition with respect to service components assigned to other component classes (e.g., a class having sponsored components may, by default, have a higher priority than a class having user-paid components). Similarly, the relative priorities of service plan classes may be predetermined within the service design center so that specification of plan class for a given plan or bundle effects an implicit priority definition with respect to service plans and bundles assigned to other plan classes. In another example, the priority of filters within a given service component may be implicitly defined by the order in which the designer incorporates the filters within the service component.

FIG. 32 also illustrates an implied priority between objects at different levels of the design hierarchy. More specifically, in the embodiment shown, all filters associated with the highest-priority component class are evaluated across the full range of plan class priorities before evaluating filters associated with the next-highest-priority component class. This hierarchical-level prioritization is demonstrated in FIG. 32 by a two dimensional “priority” grid 225 having service policy components and component classes arranged in order of descending priority along the vertical axis and service plans and plan classes arranged in order of descending priority along the horizontal axis. Individual cells within the priority grid are marked with an ‘X’ if the corresponding filter (and therefore the incorporating service policy component) is included within the corresponding service plan and left blank otherwise. As shown by the directional path overlaid on the grid, the filter evaluation order (or classification sequence) proceeds through all the filters associated with a given component class, service plan by service plan, before proceeding to the filters of the lower priority component class. With respect to a given component class, the filters associated with each service plan are evaluated according to component priority order and then according to the relative priorities of filters within a given component. In the case of service plan 1.3, for example, the filters associated with service component 1.1 (a service policy component within service component class 1) are evaluated before the filters associated with lower-priority service component 1.2, and individual filters incorporated by each service component are evaluated one after another according to their priority assignments (e.g., with respect to service component 1.2, filters are prioritized as Filter 1.1.1 >Filter 1.1.2 >Filter 1.1.3 and evaluated in that order). With regard to service plans, priority is resolved first at the plan class level and then by the relative priorities of plans within a given plan class. Thus, in the example shown, the filters associated with plans of class 1 are evaluated before the filters associated with plans of class 2, with the plans of each class being evaluated one after another according to their priority assignments (e.g., with respect to plan class 1, plans are prioritized as Plan 1.1 >Plan 1.2 >Plan 1.3 and evaluated in that order). Overall, in the priority grid layout of FIG. 32, the classification sequence follows a Z-shaped progression (“Z-order”), proceeding from left to right through the plans containing service policy components associated with the highest priority component class before retracing to the leftmost (highest-priority) plan and repeating the left-to-right progression with respect to the next-highest-priority component class.

FIG. 33 illustrates an example of a Z-ordered classification sequence with respect to the filters associated with two plan classes: sponsored and user-paid; and also two component classes: sponsored and open access. Of the four service plans shown in the priority grid, two are sponsored and two are user-paid. From an end-user's perspective, if a particular service activity of an end-user device (e.g., use of an app, access to a web site, etc.) fits both within a sponsored plan and a user-paid plan, it is desirable that the service activity be accounted to (e.g., charged to) the sponsored plan. In other words, if a particular service activity could be accounted to a sponsored plan instead of a user-paid plan, that particular service activity should be accounted to the sponsored plan. Thus, the sponsored plans should be prioritized ahead of user-paid plans. In some embodiments, sponsored plans are prioritized ahead of user-paid plans by default operation of the service design center. In some embodiments, the relative priorities of plans classes are explicitly set by a service designer. In the exemplary embodiment shown in FIG. 33, the two sponsored plans are prioritized ahead of the user-paid plans.

Although sponsored plans may be prioritized ahead of user-paid plans in a number of contexts, the converse may also be true. For example, under the concept of a “carrier backstop,” a carrier or other service provider may wish to charge certain service activities required for service plans to work (e.g., domain name server functions) first to the end-user if the end-user has a supporting plan, and then to the service provider as a backstop. Accordingly, all the prioritizing arrangements described herein should be understood to be examples, with various alternative prioritizations being permitted by design or default.

Continuing with the prioritization examples, a particular service plan could have, for instance, sponsored and user-paid components. For example, the 30-day, 10 MB general access plan of FIG. 33 has both sponsored service components and open-access service components. If a particular service activity fits within a sponsored service component, it is desirable from a user's perspective that the service activity be accounted to the sponsored service component. Only when there is no sponsored service component available should the service activity be accounted to the open-access component. Similarly, sponsored service components are prioritized ahead of open-access service components, so that sponsored Facebook and Twitter components are prioritized ahead of an open access component. Like the plan priorities, the class priorities and the component priorities may be specified by the service designer or predetermined by default operation of the service design center.

The priorities of plans within a given plan class may be explicitly assigned by the service designer, or potentially by a user through a web site or through a user interface of the end-user device. In the example of FIG. 33, the designer has designated a “one-day sponsored Twitter plan” as being higher priority than a “three-day sponsored social networking plan” (although the opposite priority arrangement may have been specified). The one-day sponsored Twitter plan provides access to Twitter for a day at no cost to the user. As shown by FIG. 33, the one-day sponsored Twitter plan includes two Twitter-related filters: a Twitter app filter and a Twitter web access filter. As also shown by FIG. 33, the two Twitter filters are within the sponsored service component class. Because the one-day sponsored Twitter plan is a sponsored plan that provides only for limited access (i.e., to Twitter), the one-day sponsored Twitter plan does not include any other app/service-specific filters (e.g., none of the illustrated Facebook filters are included), nor does it include the all-pass filter that is an open-access service component and allows unrestricted service access.

On the other hand, the three-day sponsored social networking plan includes both of the Twitter-related filters (because access to Twitter is included in the three-day sponsored social networking plan), and it also includes three Facebook filters: a Facebook app filter, a Facebook messenger filter, and a Facebook web access filter. Because the three-day sponsored social networking plan provides only for social networking access, the plan does not include the all-pass filter. Note, however, that the end-user may wish to modify the default priorities based on purchase timing and/or re-prioritize based on service usage. Such end-user prioritization controls may be selectively granted as part of the overall user experience defined within the service design center.

In the example of FIG. 33, in which the sponsored Twitter plan expires after one day, it makes sense that the priority of the one-day Twitter plan would be higher than the priority of the three-day sponsored social networking plan (e.g., service usage fitting within the one-day Twitter plan would be accounted to the one-day Twitter plan before checking whether the service usage fits within the three-day sponsored social networking plan). If, in contrast, the sponsored Twitter plan expired after seven days, the designer, a user/subscriber, or the service design center by default might instead prioritize the three-day sponsored social networking plan over the seven-day sponsored Twitter plan, because the three-day sponsored social networking plan expires first.

Similarly, FIG. 33 shows a user-paid 30-day, 10 MB general access plan with bonus, which provides for general (i.e., unrestricted) access as well as a bonus that provides for sponsored (i.e., included as a bonus in the user-paid plan) access to particular social networking services/sites (i.e., Twitter and Facebook). Therefore, the 30-day, 10 MB general access plan with bonus includes the previously-described social networking filters (i.e., the three Facebook-related filters and the two Twitter-related filters) and the all-pass filter that allows general access. Meanwhile, the non-expiring 50 MB general access plan is entirely user-paid, with no sponsored components, and therefore it includes only the all-pass filter, which allows unrestricted access. In FIG. 33, the designer (or user/subscriber, or the service design center using default rules) has prioritized the (eventually expiring) 30-day, 10 megabyte (MB) general access plan with a bonus data allocation (e.g., a carrier or network-operator provided volume of network data service provided to incentivize the user's purchase) ahead of a non-expiring 50 MB general access plan. Like the priorities of same-class plans, the priorities of same-class components may be specified by the service designer or by default by the service design center. In the example of FIG. 33, the Facebook policy component is prioritized ahead of the Twitter component, though the designer or the service design center could have reversed this order. The priorities of filters incorporated within each policy component may likewise be specified by the service designer or by a default prioritization rule in the service design center. In the example of FIG. 33, a Facebook App filter has a higher priority (i.e., will be checked for a match before) a Facebook Messenger filter, which in turn has a higher priority (i.e., will be checked for a match before) a Facebook Web Access filter. Within the Twitter component, a Twitter App filter is prioritized over a Twitter Web Access filter.

Still referring to FIG. 33, the classification sequence proceeds with regard to sponsored service components, starting with the filters of the one-day sponsored Twitter plan (the sponsored Facebook component is not included in the one-day sponsored Twitter plan as indicated by the blank priority-grid cells with respect to the three Facebook filters) and then proceeding to the filters of the three-day sponsored social networking plan and then the 30-day 10 MB general access plan with bonus. Note that both of the sponsored components include filters within the three-day sponsored social networking plan (i.e., both the sponsored Facebook component and the sponsored Twitter component are constituents of that plan) and within the 3-day 10 MB General Access plan with bonus (i.e., the bonus in this example includes the sponsored Facebook and sponsored Twitter components). By contrast, the non-expiring 50 MB General Access plan contains no sponsored components and thus no filters from sponsored service components and therefore occupies no grid cells with respect to sponsored service components. Proceeding to the open-access component class, neither of the sponsored plans contains an open access component (hence the blank cells), while both the user-paid plans include an open access component (incorporating an all-pass filter) and thus yield the final two filter evaluations in the classification sequence.

Note a use of the Twitter app by an end-user device could potentially be accounted to any one of the four plans shown in FIG. 33: (1) the one-day sponsored Twitter plan, (2) the three-day sponsored social networking plan, (3) the 30-day, 10 MB access plan with bonus, or (4) the non-expiring 50 MB general access plan (because Twitter is within general access). Applying the filter priority sequence shown in FIG. 33, a Twitter access attempt in connection with a Twitter app will match the Twitter app filter. Because the first match is under the one-day sponsored Twitter plan, if the one-day sponsored Twitter plan is still active (i.e., the one day has not expired), the access attempt will consequently be allowed and accounted to the One-Day Sponsored Twitter plan without further filter evaluation (multiple-match classification represents another possibility and is discussed below). In addition, any defined notification policy associated with a match of the Twitter app filter under the one-day sponsored Twitter plan will be triggered. After the one-day Twitter sponsorship expires, a new priority management table can be used (i.e., a table like the one of FIG. 33, but without the first column under “Sponsored Plans”), or the control action associated with a match of the Twitter app filter in the one-day sponsored Twitter plan can be associated with a control action of “block but keep looking,” which indicates that the access is not allowed under the one-day sponsored Twitter plan, but there may be another plan under which the access is allowed. It should also be noted that a match of the Twitter app filter within the one-day sponsored Twitter plan after expiration of the one-day sponsored Twitter plan, although blocked and therefore not accounted to the one-day sponsored Twitter plan, could trigger a notification policy action. For example, the fact that access was blocked could be reported to the user/subscriber or to a network element. A user/subscriber notification might inform the user that the one-day sponsored Twitter plan has expired and/or offer the user/subscriber another plan that would allow future accesses (e.g., a user-paid Twitter plan, a social networking plan, or a general access plan, to name just a few). The notification action could be based on other service plans already active for the device, such as those shown in FIG. 33. For example, because the device associated with the priority management table of FIG. 33 still has a sponsored social networking plan available, the notification might simply inform a user/subscriber that the sponsored Twitter plan has expired. But if the device did not have a plan that would provide for access to Twitter, the notification might provide service offers to the user/subscriber to enable Twitter access.

Continuing with the example of FIG. 33, the same Twitter access that would have been allowed under the one-day sponsored Twitter plan will, after expiration of the one-day sponsored Twitter plan, not be allowed in the classification sequence (i.e., will match the Twitter app filter of the one-day sponsored Twitter plan but will be blocked because the plan has expired, and will not match any of the other filters in the sequence) until reaching the Twitter App filter within the three-day sponsored social networking plan, where “allow,” “charge plan,” and notification policy actions may be triggered. Upon expiration of the Three-Day Sponsored Networking plan, the same attempted Twitter access will not be allowed (but might trigger one or more notification actions) until it reaches the Twitter App Filter incorporated within the 30-day 10 MB General Access Plan with Bonus, being allowed and accounted according to the policy definitions of that plan, starting, for example, with usage of the bonus data service allocation. After the bonus within the 30-Day, 10 MB General Access Plan is consumed, a Twitter access attempt will not be allowed within any of the sponsored service components (but may trigger one or more notification actions), but will be allowed after matching the all-pass filter of the 30-Day 10 MB General Access Plan with Bonus. Finally, after the 30-Day 10 MB General Access Plan has expired (along with all the sponsored service plans), the same Twitter access attempt will not be allowed (but may trigger one or more notification actions) until it matches the all-pass filter within the non-expiring 50 MB general access plan.

Although often it will be a service designer, through the service design center, who establishes the relative priorities of service plans, a subscriber or user can also be provided with the tools to set service plan priorities. For example, the subscriber/user may be given a “sandbox” (described) herein that allows the subscriber/user to modify the priorities of service plans. The subscriber/user may also, or alternatively, be able to establish service plan priorities through a user interface of the end-user device itself. For example, when a user selects (e.g., pays for, accepts, selects, etc.) a service plan from the end-user device, the user can be presented with an option to establish the priority of the service plan relative to other service plans associated with the device.

FIG. 34 illustrates another example of Z-ordered classification within a plan catalog having plan classes and component classes, service policy components and plans similar to those shown in FIG. 33, except that the non-expiring 50 MB General Access Plan has been replaced by a one-week 50 MB General Access Plan. Further, in the example shown, the service designer has prioritized the one-week 50 MB General Access Plan ahead of the 30-Day 10 MB General Access plan with Bonus. Because the one-week general access plan contains no sponsored policy components, any service access attempt falling within the scope of a sponsored service plan (including the sponsored components associated with the bonus data allocation within the 30-day general access plan) will match sponsored-component filters in the same sequence as in FIG. 33. By contrast, an attempted service access falling outside the scope of the sponsored components will now first match the open access filter within the one-week general access plan instead of the 30-day general access plan, thus ensuring that the shorter-lived one-week plan will be consumed ahead of the longer 30-day plan.

As the examples in FIGS. 33 and 34 demonstrate, the implied and explicit control over plan, component and filter priorities enables service usage requests within an environment of multiple applicable service plans to be accommodated and accounted for in a logical, systematic (e.g., deterministic or predictable) order, prescribed by the service designer. Moreover, it allows a rich and diverse set of notification actions to be triggered when, for example, an attempted service usage is not allowed within a particular service plan. From the reverse perspective, priority management within the service design center enables service consumers to activate a rich and diverse set of service plans with confidence that an intelligent, well designed usage and accounting priority will be applied to a service access falling within the scope of multiple active plans (i.e., no double usage-metering or accounting).

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present disclosure is not described with reference to any particular programming language, and various embodiments may thus be implemented using a variety of programming languages.

Although the foregoing embodiments have been described in some detail for purposes of clarity of understanding, the disclosure is not limited to the details provided. There are many alternative ways of implementing the disclosure. The disclosed embodiments are illustrative and not restrictive.

The section headings provided in this detailed description are for convenience of reference only, and in no way define, limit, construe or describe the scope or extent of such sections. Also, while various specific embodiments have been disclosed, it will be evident that various modifications and changes may be made thereto without departing from the broader spirit and scope of the disclosure. For example, features or aspects of any of the embodiments may be applied in combination with any other of the embodiments or in place of counterpart features or aspects thereof. The terms “exemplary” and “embodiment” are used to express an example, not a preference or requirement. Also, the terms “may” and “can” are used interchangeably to denote optional (permissible) subject matter. The absence of either term should not be construed as meaning that a given feature or technique is required. Further, in the foregoing description and in the accompanying drawings, specific terminology and drawing symbols have been set forth to provide a thorough understanding of the disclosed embodiments. In some instances, the terminology and symbols may imply implementation or operational details that are not required to practice those embodiments. Accordingly, the specification and drawings are to be regarded in an illustrative rather than a restrictive sense.

### INCORPORATION BY REFERENCE

This application incorporates by reference the following US patent applications for all purposes: Provisional Application No. 62/236,850 entitled “Wireless Device with Configurable Network Activity Management and Generic Kernel Support,” filed on Oct. 2, 2016; and Provisional Application No. 62/258,279 entitled “Mobile Device with In-Situ Network Activity Management,” filed on Nov. 20, 2015.

What is claimed is:

1. A non-transitory computer media comprising computer instructions for execution in an operating system kernel, the instructions, when executed, performing a method comprising:
maintaining a plurality of data buckets, each data bucket containing a respective data count;
inspecting the packets of a plurality of network packet data flows at a point in a network stack;
receiving, from a user space process, a data allotment, identified with a first one of the data buckets;
associating the first data bucket with the data allotment;
receiving, from the user space process, a first instruction to associate a first one of the network packet data flows with the first data bucket;
for each packet inspected in the first network packet data flow,
making a determination as to whether the data count of the first data bucket, adjusted for the data count of that packet, would at least reach a depletion limit;
based on the determination indicating that the adjusted data count of the first data bucket would not at least reach the depletion limit, allowing the packet to continue through the network stack, and updating the data count of the first data bucket to account for the data count of that packet, and
based on the determination indicating that the adjusted data count of the first data bucket would at least reach the depletion limit, notifying the user space process of a depletion event status of the first data bucket; and
reporting to the user space process, at a time that a depletion event status is not current for the first data bucket, a current data count of the first data bucket.
